(19) United States
(12) Patent Application Publication
(10) Pub. No.: US 2023/0021998 A1
(43) Pub. Date: Jan. 26, 2023

(54) 3-D PRINTED CARBON NANOTUBE REINFORCED TITANIUM COMPOSITES AND METHODS

(71) Applicant: THE UNITED STATES OF AMERICA, AS REPRESENTED BY THE SECRETARY OF THE NAVY, Arlington, VA (US)

(72) Inventors: Andy Nieto, Morgan Hill, CA (US); Anthony Michael DeMartino, Glendale, AZ (US)

(21) Appl. No.: 17/862,166

(22) Filed: Jul. 11, 2022

Related U.S. Application Data
(60) Provisional application No. 63/220,503, filed on Jul. 10, 2021.

(51) Int. Cl. B22F 10/28; B22F 9/04

(52) U.S. Cl. CPC B22F 10/28; B22F 9/04; B22F 2302/403; B22F 2301/205; B22F 2009/043

(57) ABSTRACT

This disclosure, and the exemplary embodiments provided herein, include 3D printed titanium composites and methods including 1 vol. % carbon nanotube reinforcements on selective laser melt printed Ti64. The interrelationships with laser energy density, laser power, and laser scan speed are demonstrated and discussed. Utilizing selective laser melting, according to one exemplary embodiment of this disclosure, a >99% dense Ti-CNT composite is disclosed with microhardness of 4.75 GPa—a 30% enhancement over its Ti64 counterpart.

### CROSS REFERENCE TO RELATED PATENT(S) AND APPLICATION(S)

This application claims the benefit of U.S. Provisional Application No. 63/220,503 filed Jul. 10, 2021, and entitled 3D PRINTED CARBON NANOTUBE REINFORCED TITANIUM COMPOSITES, which is hereby incorporated in its entirety by reference.

### BACKGROUND

The present exemplary embodiment relates to 3D PRINTED CARBON NANOTUBE REINFORCED TITANIUM COMPOSITES AND METHODS. It finds particular application in conjunction with methods to generate carbon nanotube reinforced titanium composites and printing using said composites using a support structure, and will be described with particular reference thereto. However, it is to be appreciated that the present exemplary embodiment is also amenable to other like applications.

As we progress into the 21st century, the need and desire to operate farther, faster, and for longer durations will require new, lighter materials that can withstand the increased loads. Reinforced metal matrix composites are a promising avenue for achieving this goal. Ti-6Al-4V has been a useful material in the aerospace and medical industries for decades due to its incredible strength-to-weight ratio, and now its suitability for additive manufacturing has made it even more desirable. One of the leading-edge reinforcements being studied for metal matrix composites are carbon nanotubes, due to their remarkable mechanical properties such as strength and elastic modulus. It is desirable to manufacture these materials of the future using modern manufacturing tools, such as additive metal processing. This disclosure describes the effect of 1 vol. % carbon nanotube reinforcements on the microstructural evolution and properties of selective laser melt printed Ti64, and the interrelationships with laser energy density, laser power, and laser scan speed. The effectiveness of reinforcement and influence of printing parameters were assessed via microstructural and porosity analysis, and microhardness testing. Utilizing selective laser melting, a >99% dense Ti-CNT composite was manufactured with microhardness of 4.75 GPa—a 30% enhancement over its Ti64 counterpart.

### INCORPORATION BY REFERENCE

The following publications are incorporated by reference in their entirety.
[Reference 1] A. Saboori, D. Gallo, S. Biamino, P. Fino, and M. Lombardi, “An overview of additive manufacturing of titanium components by directed energy deposition: microstructure and mechanical properties,” Applied Sciences, vol. 7, no. 9, p. 883, August 2017.
[Reference 2] H. K. Rafi, N. V. Karthik, H. Gong, T. L. Starr, and B. E. Stucker, “Microstructures and mechanical properties of ti6al4v parts fabricated by selective laser melting and electron beam melting,” J. of Mat Eng and Perf, Vol. 22, no. 12, pp. 3872-3883, December 2013.
[Reference 3] F. Calignano et al., “Overview on additive manufacturing technologies,” Proc. IEEE, vol. 105, no. 4, pp. 593-612, April 2017.
[Reference 4] L. E. Murr, Handbook of Materials Structures, Properties, Processing and Performance, New York, N.Y., USA: Springer International Publishing, 2015, pp. 665-686.
[Reference 5] R. Pederson, ‘Microstructure and phase transformation of Ti-6Al-4V’, Licentiate dissertation, Lulea Tekniska Universitet, Lulea, Sweden 2002.
[Reference 6] S. Cranford, H. Yao, C. Ortiz, and M. J. Buehler, “A single degree of freedom ‘lollipop’ model for carbon nanotube bundle formation,” Journal of the Mechanics and Physics of Solids, vol. 58, no. 3, pp. 409-427, March 2010.
[Reference 7] Y. H. Li, W. Housten, Y. Zhao, and Y. Q. Zhu, “Cu/single-walled carbon nanotube laminate composites fabricated by cold rolling and annealing,” Nanotechnology, vol. 18, no. 20, p. 205607, May 2007.
[Reference 8] J. Liu, D.-B. Xiong, Y. Su, Q. Guo, Z. Li, and D. Zhang, “Effect of thermal cycling on the mechanical properties of carbon nanotubes reinforced copper matrix nanolaminated composites,” Materials Science and Engineering: A, vol. 739, pp. 132-139, January 2019.
[Reference 9] S. Simões, F. Viana, M. Reis, and M. Vieira, “Aluminum and nickel matrix composites reinforced by cnts: dispersion/mixture by ultrasonication,” Metals, vol. 7, no. 7, p. 279, July 2017.
[Reference 10] K. Kondoh, T. Threrujirapapong, H. Imai, J. Umeda, and B. Fugetsu, “Characteristics of powder metallurgy pure titanium matrix composite reinforced with multi-wall carbon nanotubes,” Composites Science and Technology, vol. 69, no. 7-8, pp. 1077-1081, June 2009.
[Reference 11] T. Kuzumaki, O. Ujiie, H. Ichinose, and K. Ito, “Mechanical characteristics and preparation of carbon nanotube fiber-reinforced ti composite,” Advanced Engineering Materials, vol. 2, no. 7, pp. 416-418, 2000.
[Reference 12] H. Jia, Z. Zhang, Z. Qi, G. Liu, and X. Bian, “Formation of nanocrystalline TiC from titanium and different carbon sources by mechanical alloying,” Journal of Alloys and Compounds, vol. 472, no. 1-2, pp. 97-103, March 2009.
[Reference 13] T. Ahmed and H. J. Rack, “Phase transformations during cooling in α+β titanium alloys,” Materials Science and Engineering: A, vol. 243, no. 1-2, pp. 206-211, March 1998.
[Reference 14] M. Yakout, M. A. Elbestawi, S. C. Veldhuis, and S. Nangle-Smith, “Influence of thermal properties on residual stresses in SLM of aerospace alloys,” RPJ, vol. 26, no. 1, pp. 213-222, January 2020.
[Reference 15] L. Thijs, K. Kempen, J.-P. Kruth, and J. Van Humbeeck, “Fine-structured aluminium products with controllable texture by selective laser melting of pre-alloyed AlSi10 Mg powder,” Acta Materialia, vol. 61, no. 5, pp. 1809-1819, March 2013.
[Reference 16] M. Yakout, M. A. Elbestawi, and S. C. Veldhuis, “A study of the relationship between thermal expansion and residual stresses in selective laser melting of Ti-6Al-4V,” Journal of Manufacturing Processes, vol. 52, pp. 181-192, April 2020.
[Reference 17] D. Sun et al., “Selective laser melting of titanium parts: Influence of laser process parameters on macro- and microstructures and tensile property,” Powder Technology, vol. 342, pp. 371-379, January 2019.
[Reference 18] K. Chang and D. Gu, “Direct metal laser sintering synthesis of carbon nanotube reinforced Ti matrix composites: Densification, distribution characteristics and properties,” J. Mater. Res., vol. 31, no. 2, pp. 281-291, January 2016.

[Reference 19] C. Qiu, C. Panwisawas, M. Ward, H. C. Basoalto, J. W. Brooks, and M. M. Attallah, “On the role of melt flow into the surface structure and porosity development during selective laser melting,” Acta Materialia, vol. 96, pp. 72-79, September 2015.
[Reference 20] D. Gu et al., “Carbon nanotubes enabled laser 3D printing of high-performance titanium with highly concentrated reinforcement,” iScience, vol. 23, no. 9, p. 101498, September 2020.
[Reference 21] EOS, “EOS titanium ti64 flexline.” Aug. 22, 2017. [Reference 22] T. Y. Ansell, T. Hanneman, A. Gonzalez-Perez, C. Park, and A. Nieto, “Effect of high energy ball milling on spherical metallic powder particulates for additive manufacturing,” Particulate Science and Technology, pp. 1-9, February 2021.
[Reference 23] D. J. Woo, J. P. Hooper, S. Osswald, B. A. Bottolfson, and L. N. Brewer, “Low temperature synthesis of carbon nanotube-reinforced aluminum metal composite powders using cryogenic milling,” J. Mater. Res., vol. 29, no. 22, pp. 2644-2656, November 2014.
[Reference 24] R. S. Ring, “Technical Description EOS M 100.” EOS, November 2015.
[Reference 25] W. M. Tucho, V. H. Lysne, H. Austbø, A. Sjolyst-Kverneland, and V. Hansen, “Investigation of effects of process parameters on microstructure and hardness of SLM manufactured SS316L,” Journal of Alloys and Compounds, vol. 740, pp. 910-925, April 2018.
[Reference 26] P. Kim, L. Shi, A. Majumdar, and P. L. McEuen, “Thermal transport measurements of individual multiwalled nanotubes,” Phys. Rev. Lett., vol. 87, no. 21, p. 215502, October 2001.
[Reference 27] T. Majumdar, T. Bazin, E. Massahud Carvalho Ribeiro, J. E. Frith, and N. Birbilis, “Understanding the effects of PBF process parameter interplay on Ti-6Al-4V surface properties,” PLoS ONE, vol. 14, no. 8, p. e0221198, August 2019.
[Reference 28] I. Barin and G. Platzki, Thermochemical Data Of Pure Substances, 3rd ed. New York, N.Y., USA: Weinheim VCH, 1995.
[Reference 29] H. H. Alsalla, C. Smith, and L. Hao, “The effect of different build orientations on the consolidation, tensile and fracture toughness properties of direct metal laser sintering Ti-6Al-4V,” RPJ, vol. 24, no. 2, pp. 276-284, March 2018.
[Reference 30] N. Singh, P. Hameed, R. Ummethala, G. Manivasagam, K. G. Prashanth, and J. Eckert, “Selective laser manufacturing of Ti-based alloys and composites: impact of process parameters, application trends, and future prospects,” Materials Today Advances, vol. 8, p. 100097, December 2020.
[Reference 31] L.-C. Zhang and H. Attar, “Selective laser melting of titanium alloys and titanium matrix composites for biomedical applications: a review: selective laser melting of titanium alloys,” Adv. Eng. Mater., vol. 18, no. 4, pp. 463-475, April 2016.
[Reference 32] R. E. Smallman and R. J. Bishop, Modern Physical Metallurgy and Materials Engineering: Science, Process, Applications, 6th ed. Oxford, Boston, Mass., USA: Butterworth Heinemann, 1999.
[Reference 33] W. Duckworth, “Discussion of Ryshkewitch Paper by Winston Duckworth*,” J American Ceramic Society, vol. 36, no. 2, pp. 68-68, February 1953.

### BRIEF DESCRIPTION

In accordance with one embodiment of the present disclosure, disclosed is a method of 3D printing carbon nanotube reinforced titanium composites comprising: generating a composite powder by combining a titanium material and a carbon nanotube material in a high energy ball mill, wherein the high energy ball mill is used to perform multiple milling cycles, wherein each of the multiple milling cycles is approximately one to five minutes of milling followed by approximately one to ten minutes of inactivity for cool-down; configuring a support structure for supporting a metal component, wherein the custom support structure comprises large cylindrical support structures along an edge of a target print area of the metal component, wherein each of the large cylindrical support structures are larger than a default cylindrical support structure of a 3D printing software; and printing, using a selective laser melting machine, the metal component and the support structure with the compositive powder.

In accordance with another embodiment of the present disclosure, disclosed is a 3D printed carbon nanotube reinforced titanium composite comprising: a carbon nanotube; and a titanium material, particles of the carbon nanotube being embedded in the titanium material such that minimal to no porosity is exhibited at an interface of the titanium material and the oxide; and a support portion of the titanium composite arranged in a support structure for supporting a metal component comprising a component portion of the titanium composite, the custom support structure comprising large cylindrical support structures along an edge of a target print area, wherein each of the large cylindrical support structures have a minimal thickness to prevent damage caused by thermal stresses of 3D printing.

In accordance with another embodiment of the present disclosure, disclosed is a method of 3D printing reinforced titanium composites comprising: generating a composite powder by combining a titanium material and a carbon nanotube in a high energy ball mill, wherein the high energy ball mill is used to perform multiple milling cycles, wherein each of the multiple milling cycles is at least one minute of milling followed by at least one minute of inactivity for cool-down; configuring a support structure for supporting a metal component, wherein the support structure comprises large cylindrical support structures along an edge of a target print area of the metal component; and printing, using a selective laser melting machine, the metal component and the support structure with the compositive powder.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

For a more complete understanding of the present disclosure, reference is now made to the following descriptions taken in conjunction with the accompanying drawings, in which:

FIG. 1 is a flow chart of a method of 3D printing carbon nanotube reinforced titanium composites according to an exemplary embodiment of this disclosure;

FIGS. 2A-2C show common commercial metal 3D printing methods: DED (FIG. 2A), EBM (FIG. 2B), and SLM (FIG. 2C). Sources: [Reference 3];

FIGS. 3A-3D show Pullout of CNTs from a roll-bonded Cu-CNT composite: SEM images (FIGS. 3A-3C) and TEM image (FIG. 3D). Source: [Reference 7];

FIGS. 4A-4F show TEM images of laminated CNTs/Cu composite subjected to 20 thermal cycles: before (FIGS. 4A-4C) and after (FIGS. 4D-4F) tensile testing. Source: [Reference 8];

FIG. 5 shows an SEM image of the Al/CNT nanocomposites produced with 1.00 vol % of CNTs. Source: [Reference 9];

FIG. 6 shows an XRD of milled CNTs and Titanium powder at increasing milling times. Source: [Reference 12];

FIG. 7 shows an HRTEM image of CNT within Titanium matrix. Source: [Reference 11];

FIGS. 8A-8B show SEM images of (FIG. 8A) Ti powder coated with unbundled CNTs and solid surfactant (FIG. 8B) tensile fractured surface showing CNT reinforcement;

FIG. 9 shows a continuous cooling diagram for Ti-6Al-4V □-solution treated at 1050° C. for 30 min. Source: [Reference 13];

FIGS. 10A-10C show a comparison of Ti64 microstructure for: wrought (FIG. 10A), EBM increased cooling rates (FIG. 10B), and SLM (FIG. 10C) with high cooling rates. Source: (FIG. 10A; [Reference 10]), and (FIGS. 10B and 10C, [Reference 13]);

FIG. 11 shows a SLM printed Ti64 (z-axis) deformation profile. Source: [Reference 14];

FIG. 12 shows the Relative density vs. Laser Energy Density of SLM printed Ti64. Source: [Reference 16];

FIGS. 13A-13C shows SEM images of CNT coated onto spherical CP—Ti powder. Source: [Reference 20];

FIGS. 14A and 14B show Illustrations of improved wettability of titanium onto CNTs. Source: [Reference 18];

FIGS. 15A-15C show SEM images of: MWCNT bundle (FIG. 15A), CNTs within the bundle at medium magnification (FIG. 15B), and at high magnification (FIG. 15C);

FIGS. 16A and 16B show SEM images of bulk Ti64 powder;

FIG. 17 is an Illustration of EOS M100 operations;

FIGS. 18A-18C show failed large geometry prints with increasing support volume left to right (FIG. 18A to FIG. 18C);

FIGS. 19A-19D show supports generated in MATERIALISE MAGICS Software: cylinder support (FIGS. 19A/B) and full volume supports (FIGS. 19C/D);

FIG. 20 shows mounted, polished, etched, and sputter coated samples prepared for SEM analysis;

FIG. 21 shows Vickers Hardness HV Impression Measurements;

FIG. 22 shows Composite powder 1:10 BPR. Red arrows indicating location of disassociated CNT bundles;

FIG. 23 shows SEM image with enhanced magnification of CNT agglomerate in 1:10 BPR composite powder;

FIG. 24 shows SEM image of composite powder post milling at 1:1 BPR;

FIG. 25 shows SEM image of composite powder with lubricant post milling at 2:1 BPR;

FIG. 26 shows SEM image of composite powder post milling at 2:1 BPR without lubricant;

FIG. 27 shows survived CNT adhered to Ti64 powder surface;

FIGS. 28A and 28B show comparison SEM images taken of composite powder milled at (FIG. 28A) 2:1 BPR (FIG. 28B) 1:1 BP;

FIGS. 29A and 29B show SEM images of recycled, composite powder;

FIG. 30 shows Part Density vs Energy Density for SLM printed Ti64 and Ti-CNT Composite;

FIGS. 31A-31F show OM cross-sections processed by ImageJ software for porosity analysis: SLM Ti64 (FIG. 31A-31C), SLM Ti-CNT composite (FIG. 31D-31F);

FIG. 32 shows SEM image of pores on surface of e278 Ti-CNT cross-section;

FIG. 33 shows Percent Density vs Power for SLM printed Ti64 and Ti-CNT Composite;

FIG. 34 shows Diffraction pattern for SLM printed Ti64 and Ti-CNT composite at varying energy densities;

FIG. 35 shows Ti-6Al-V4 Phase diagram. Source: [Reference 36];

FIG. 36 shows Magnified XRD diffraction pattern for Ti64 and Ti-CNT composite identifying formation of TiCₓ;

FIGS. 37A-37F show OM images of etched SLM printed cross-sections: Ti64 at e60, e278, e417 respectively (FIGS. 37A-37C), Ti-CNT composite at e60, e278, e417 respectively (FIGS. 37D-37F);

FIGS. 38A and 38B show High magnification SEM image of SLM printed: Ti64 (FIG. 38A) and Ti-CNT composite (FIG. 38B);

FIGS. 39A-39F show SEM low-mag images of etched SLM printed coupons: Ti64 at e60, e278, e417 respectively (FIGS. 39A-39C), Ti-CNT composite at e60, e278, e417 respectively (FIGS. 39D-39F);

FIGS. 40A and 40B show Microhardness test sites at: Low magnification OM (FIG. 40A), and diamond indent from DuraScan tester (FIG. 40B);

FIG. 41 shows Hardness vs. laser energy density plot comparing printed Ti-CNT composite and Ti64 parts;

FIG. 42 shows Plot of hardness vs. power for constant E regimes of e60 and e417 for the printed composite and Ti64 parts; and

FIGS. 43A-43D show Observed CNTs in printed Ti-CNT composite (FIGS. 43A-43B) e60 (FIGS. 43C-43D) e278.

### DETAILED DESCRIPTION

Stephen Hawking, one of the greatest theoretical physicists of the last century, stated, “To confine our attention to terrestrial matters would be to limit the human spirit.” As mankind progresses into the 21st century, the desires to go further and faster necessitate materials that can withstand the associated forces and heat loads. This is especially true in space, where not only is strength important, but weight and endurance in the harsh environment beyond our atmosphere become key. Composites provide a unique opportunity to accomplish this task by relying on the given properties of known materials, and enhancing them with a reinforcing structure. Since their discoveries, carbon nanotubes (CNT) have been the darling structures for material scientists around the world due to their mechanical, electrical, and thermal properties. With respect to composites, it is their mechanical properties (Young's modulus ˜1 TPa and Tensile Strength ˜100 GPa respectively), which make them an attractive reinforcement for Ti-6Al-4V (Ti64)—a widely accepted material throughout the aerospace and medical industries.

One enterprise in particular that is positioned to greatly benefit from this technology is the space industry where payload and weight considerations are paramount. As a result, when it comes to material selections for space applications, one of the most significant deciding factors is its strength-to-weight ratio. Until the recent development and launch of the Falcon 9 rocket, the average launch cost was $18,500/kg. While that number has been drastically reduced by SpaceX's efforts to approximately $2700/kg, payload weight is still a driving factor in the limitations of research and exploration in this domain. This has led to titanium, and its alloys, as a common material of choice in the aerospace domain, due to its high strength, and relatively low density. The potential to reinforce this known material with CNTs will not only further enhance this desirable strength-to-weight ratio, but also improve upon some of titanium's natural drawbacks, such as wear resistance (hardness) and Young's Modulus compared to steel.

Along with this push to go farther and faster, is the need to improve efficiencies, and reduce material consumption and cost. 3D printing has been a rapidly advancing method of additive manufacturing (AM) technology in the last decade—shifting from basic polymers to metals and composites. The bottom-up format of additive manufacturing allows for minimizing waste in the fabrication of parts, tools, and components with the exact amount of material required. It gives engineers the ability to move from design to production, through a vast range of scalability, resulting in decreased delivery timelines. This disclosure, and the exemplary embodiments described herein, combine this technology with that of carbon nanostructures in a production of a printable composite.

The value of additive manufacturing has been known and applied for over 20 years; however, the 3D printing of metal is still relatively new. In 2011, NASA launched the Juno satellite designed with 3D printed titanium connecting brackets. That satellite has been orbiting Jupiter since 2016.

CNTs metal matrix composites (MMC) are still at the preliminary research stage, and novel materials require extensive testing and characterization to ensure survival during critical operations. Since 2000, NASA has expressed interest in carbon nanotubes through its own research, and the funding of research through its business and university partners. As recently as 2017, they tested the proof of concept utilizing CNTs in a Composite Overwrapped Pressure Vessel (COPV) onboard a launched, sounding rocket. The industry is hungry for this innovation and the potential improvements to strength, and reduction in time and cost. Overcoming the challenges associated with carbon nanostructures in MMCs, described below, opens a gateway to innovation and exploration.

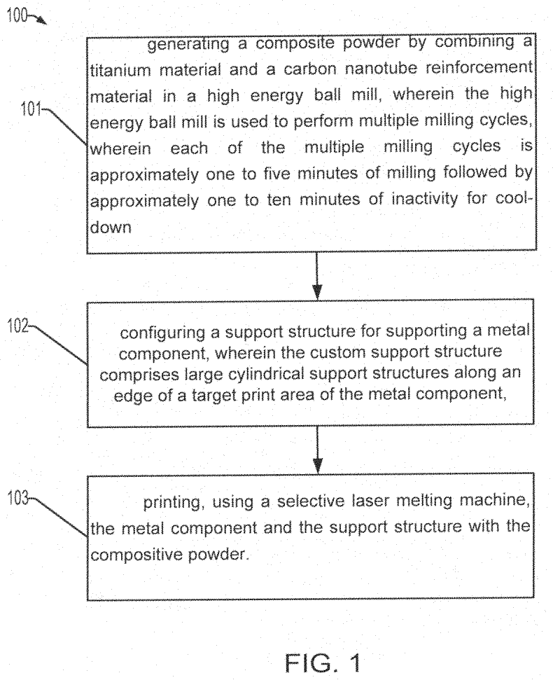

With reference to FIG. 1, shown is a flow chart of a method of 3D printing carbon nanotube reinforced titanium composites according to an exemplary embodiment of this disclosure.

Initially, at step 102, the method generates a composite powder by combining a titanium material and a carbon nanotube reinforcement material in a high energy ball mill, wherein the high energy ball mill is used to perform multiple milling cycles, wherein each of the multiple milling cycles is approximately one to five minutes of milling followed by approximately one to ten minutes of inactivity for cool-down.

It is to be understood that this disclosure, and the exemplary embodiments described, are not limited to multiple milling cycles of approximately one to five minutes of milling followed by approximately one to ten minutes of inactivity for cool-down. Other processing parameters include multiple milling cycles, wherein each milling cycle is at least one minute of milling followed by at least one minute of inactivity for cool-down. According to one exemplary embodiment, the process includes multiple milling cycles, wherein each milling cycle is approximately two minutes of milling followed by approximately five minute of inactivity for cool-down.

Next, at step 102, the method configures a support structure for supporting a metal component, wherein the custom support structure comprises large cylindrical support structures along an edge of a target print area of the metal component.

Next, at step 103, the method 3D prints, using a selective laser melting machine, the metal component and the support structure with the compositive powder.

Now provided below, are further details of the disclosed 3D Printed Carbon Nanotube Reinforced Titanium Composites and Methods.

Additive Manufacturing of Metals

Additive manufacturing (AM) is a process for fabricating three-dimensional objects via the production and buildup of fine layers of a given material. The primary driver for this innovation is the ability to seamlessly move from digital, computer-aided design (CAD) to a final, complex product saving both time and money over traditional subtractive fabrication methods, such as machining, that lead to significant material wastage. There are two primary means of metal AM, Direct Energy Deposition (DED) and Powder Bed Fusion (PBF). DED is an in-situ process of directly melting a stream of metal wire or powder using a higher energy source, such as laser, and laying down the melt layer-by-layer. Analogous to the age-old method of cladding, DED allows for large-scale production in a 5-axis format similar to its top-down counterpart of milling [1]. PBF entails a means of laying down a layer of metal powder, which is subsequently fused through various methods, before the next powder layer is added on top. While there are lower energy methods, which involve sintering of these powders for fusion, these methods often leave material porous. However, there are various methods, which involve direct melting of the powders to result in a fusion welded, finished product.

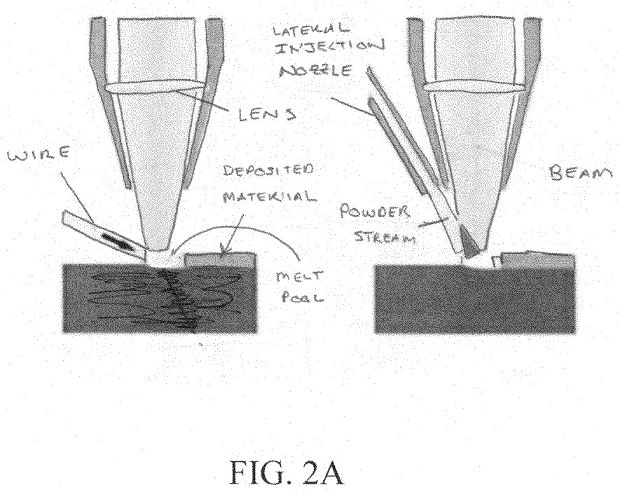

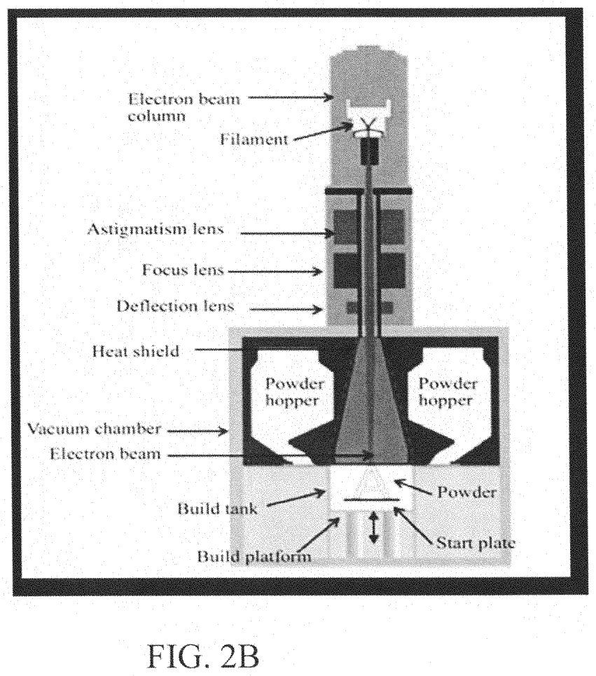

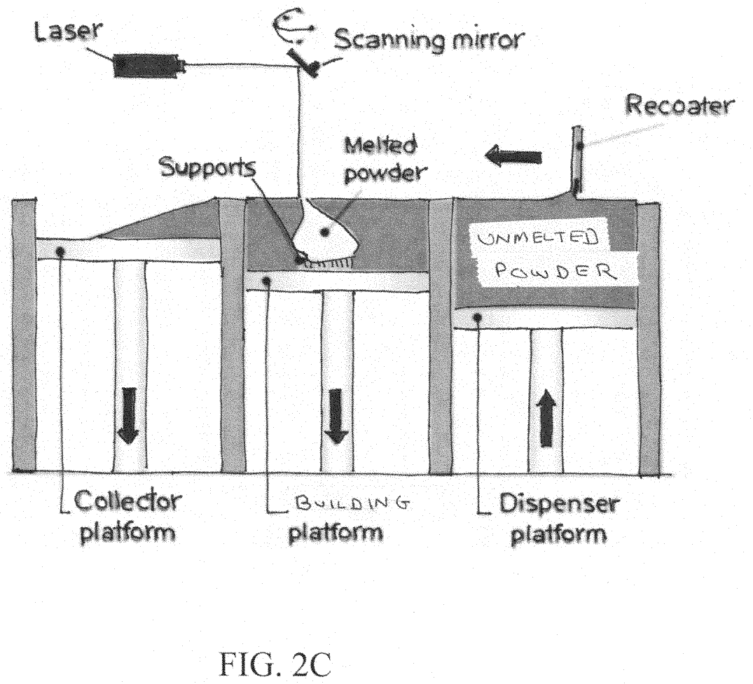

Electron beam melting (EBM) and select laser melting (SLM) are the most common methods of direct melt PBF, and while they are similar in concept and construction, they utilize a different process to heat the powder to melting. EBM operates in a large vacuum, extracting and accelerating electrons using a large potential (i.e., 60 kV), which then bombard the powder bed surface in an x-y pattern. Commonly this is accomplished by a rapid initial pass, which preheats the powder to approximately 80% melting temperature of the material, followed by a subsequent slower pass generating the desired melt pool based on the input from the CAD software. SLM on the other hand uses a focused, fiber laser (typically Yb), which is directed to a CAD controlled mirror, which controls the raster pattern (in x-y, x, or y direction) incident onto the powder bed. Unlike EBM, which operates in a vacuum, the SLM has a constant purge of Argon gas, which assists in component cooling and prevents oxidation [Reference 2]. An example of these three processes is illustrated in FIGS. 2A, 2B and 2C.

With respect to AM of Ti64 powders, which this disclosure provides, the difference in cooling rates between EBM and SLM has a significant impact on the final microstructure and therefore properties of the material. The primary driving factors that control this microstructure are the process and cooling rates. Both the preheating step of EBM for each layer and the continuous purging Ar flow of SLM, result in SLM having much higher cooling rates than EBM. These higher cooling rates of the SLM results in a microstructure dominated by α′ (martensitic) phase in addition to α and β phases, whereas the slower cooling rates of EBM forms a more coarse, lamellar structure of α and β phases. The end result is increased strength in the SLM fabricated material [Reference 2], [Reference 4], [Reference 5].

CNT Reinforced Metal Matrix Composites (CNT-MMC)

The benefits of producing CNT metal matrix composites (MMCs) has been discussed above, however there are inherent obstacles to overcome when working with CNTs as reinforcement. One of the most significant challenges to overcome when using these for composite reinforcements is achieving a uniform dispersion throughout a desired matrix. This is necessary to not only transfer the desired properties of the reinforcements to the matrix, but also to avoid stress concentrations in the final product. There are two main properties of CNTs that create this issue: large surface area-to-volume ratio and low chemical reactivity.

The large surface-area-to-volume-ratio of CNTs aids in two negative effects for dispersion within a desired solution. The combined effect of large surface area and the natural Van der Waals forces generated between carbon atoms drives the agglomeration of CNTs. Additionally, their inert nature due to the carbon-sp2 bonding throughout their structure, results in poor wettability, which contributes to poor dispersion and poor interfacial bonding with most metal matrices.

CNT-MMC Mixing Methods

A homogenous dispersion of CNTs, and strong interfacial bond are necessary to achieve uniform and enhanced properties throughout a produced composite. To deagglomerate the CNTs it has been shown that a strain energy proportional to the length of the nanotubes must be applied to overcome the Van der Waal forces that bind them [Reference 6]. In recent years, there have been several attempts at achieving this dispersion and interfacial adhesion.

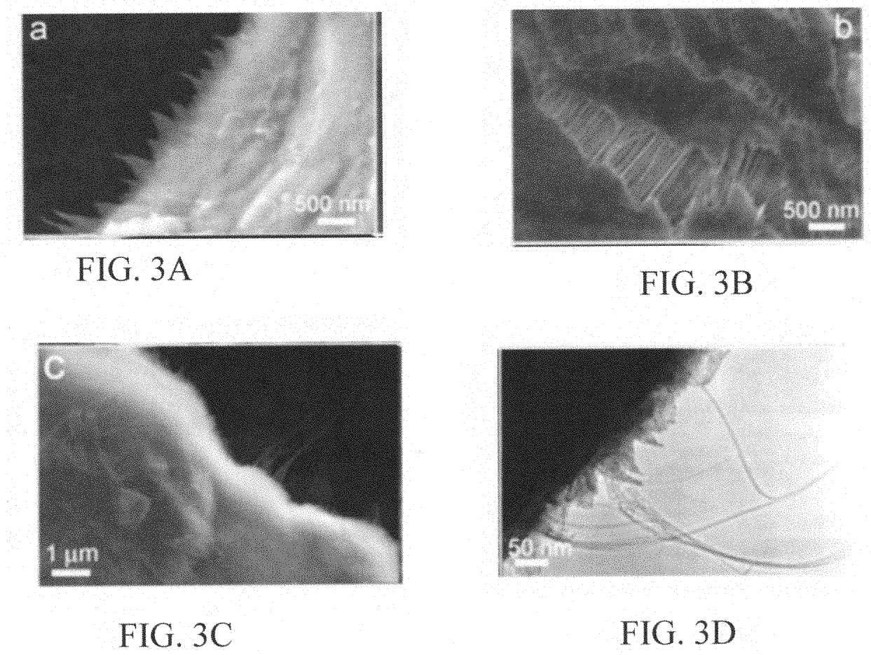

Li et al. [Reference 7] attempted to uniformly disperse SWNTs within a copper matrix by developing a SWNT film and roll bonding stacked layers of SWNT film and copper foil. The result showed uniform dispersion of the CNTs within the composite, and a 13% increase in Young's Modulus. Under load, the part failed via CNT pullout, as depicted in FIG. 3A-3D, validating successful interfacial bonding with the matrix.

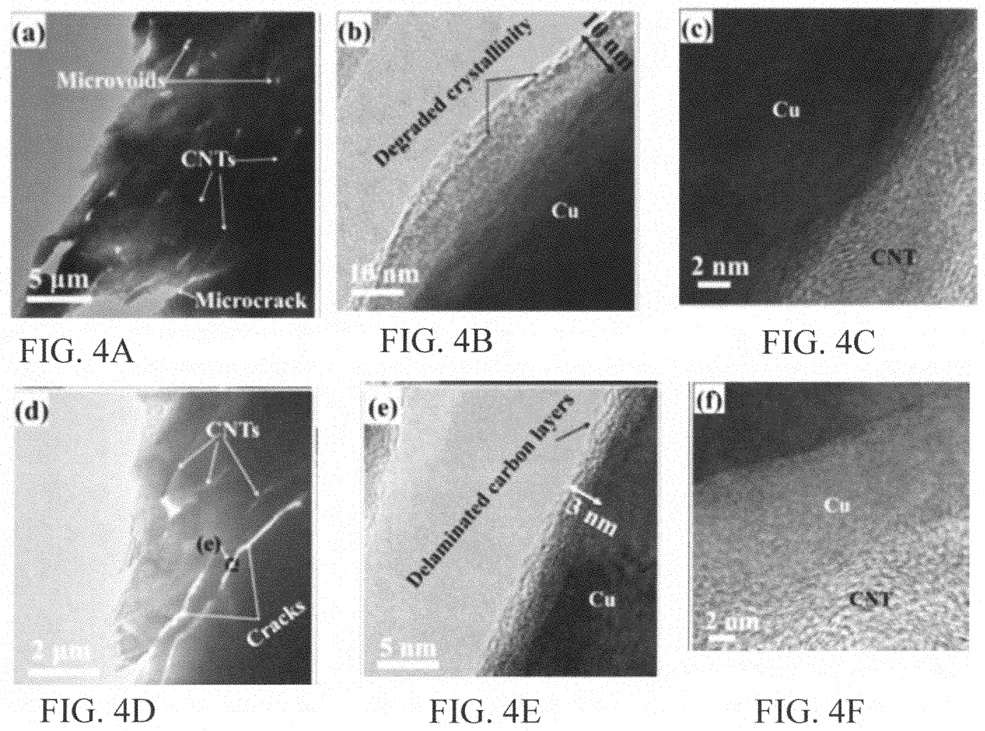

Liu et al. [Reference 8] produced a slurry of copper flakes and suspended, functionalized multi-wall CNTs (MWCNT), which were then dried, hot pressed, and hot rolled. They found good dispersion of MWCNTs and the composite showed a 69% increase in strength. However, these strength improvements decreased readily upon thermal cycling, due to interfacial sliding and debonding of the MWCNT and the copper matrix as depicted in FIGS. 4A-4F.

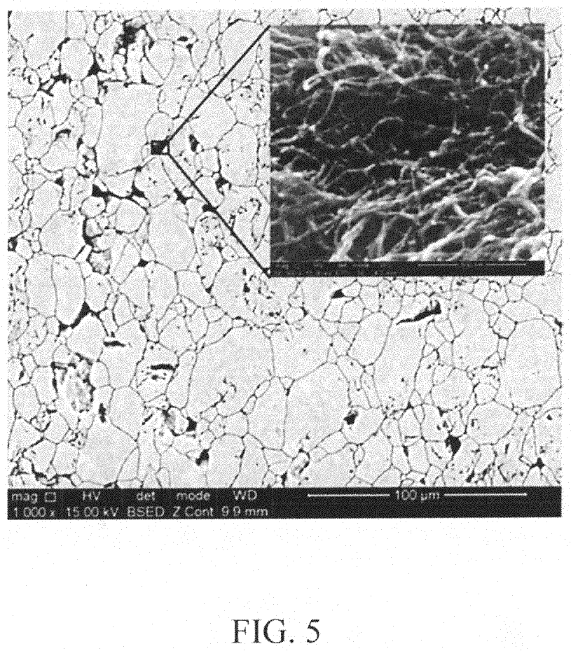

Simões et al. [Reference 9] worked with aluminum, one of the most studied materials for CNT reinforcement, and combined varying volume percent of MWCNTs using ultrasonication for dispersion. The resulting powders were dried, hot pressed, and sintered. They found good dispersion of the MWCNTs (FIG. 5) and up to a 47% improvement in hardness until the reinforcement exceeded 1 vol %. Any further increase in CNT content resulted in increased re-agglomeration of CNTs within the matrix resulting in a decreasing hardness.

Titanium-CNT MMC Methods

Studies have been done looking at the reinforcement of Titanium with CNTs and the methods utilized to overcome the challenges of dispersion and matrix adhesion. The most common applied strategy for overcoming CNT dispersion in MMCs is through powder metallurgy. While there are many different variations of this, the two most popular methods are the applications of surfactants to decrease the surface energy of the CNTs, or mechanical mixing to apply a strain force large enough to overcome the agglomeration forces in the CNT bundles. Both come with their own considerations such as post treatment removal of surfactants [Reference 10], and preventing excessive CNT damage/shortening [Reference 11] respectively. In relation to the challenge of forming a strong interfacial bond, it has been discovered that the zigzag planes and armchair planes of CNTs tend to react well with titanium to form TiC [Reference 11]. This carbide formation at the boundary appears to be vital in transferring the nanotubes reinforcement to the Titanium matrix.

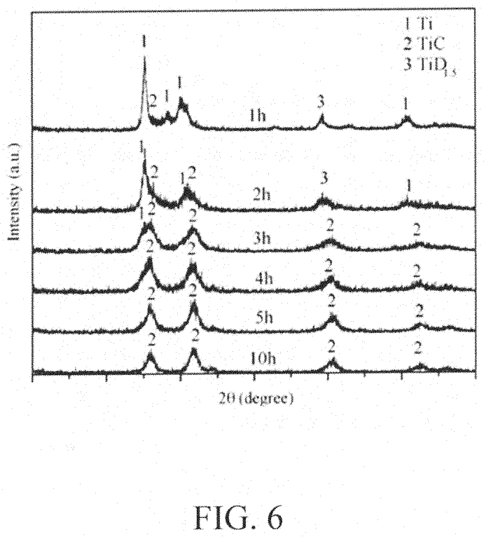

While historically it was believed that TiC could typically only be formed through high temperature reactions, Jia et al. [Reference 12] showed that through mechanical mixing using a high energy ball mill, TiC could form between CNTs and Titanium powder. However, they also showed that as these milling times increased the CNTs would be destroyed, losing their advantageous structures and eventually reacting in totality toward TiC formation as illustrated in the x-ray diffraction (XRD) plots of FIG. 6.

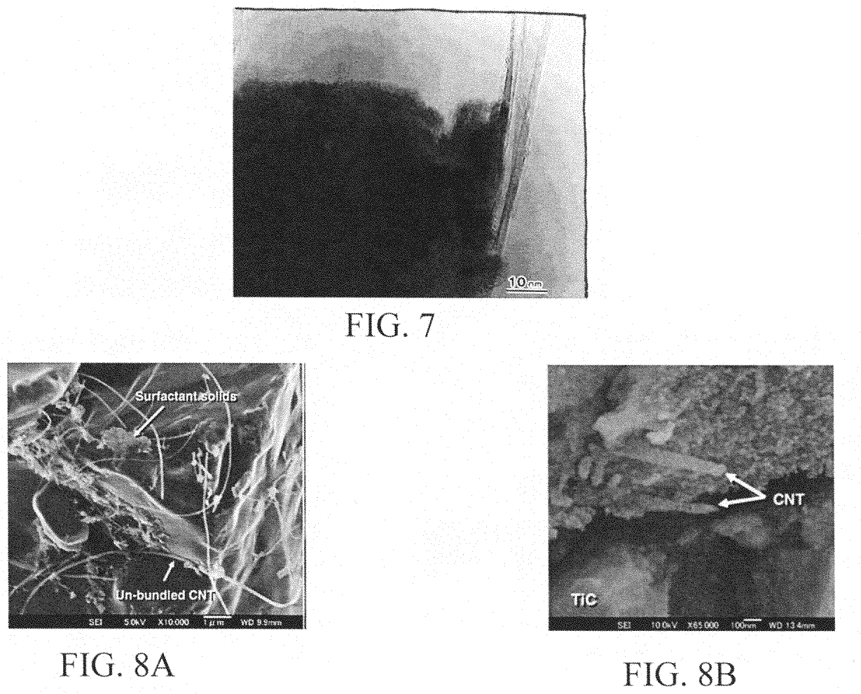

Kuzumaki et al. [Reference 11] similarly utilized mechanical mixing for five hours to disperse the CNTs within their Titanium powder, which was subsequently hot pressed to form the composite. XRD of their material showed the presence of TiC, however they were not able to identify it via transmission electron microscope (TEM) in FIG. 7. Their research showed well distributed CNTs within the composite had a 65% increase in Young's Modulus and an astounding 550% increase in hardness, which they attribute to the carbide formation and CNTs preventing dislocation motion.

Kondoh et al. [Reference 10] went the route of using a surfactant solution to disperse varying weight percent MWCNTs. They then dipped Ti64 powder into the solution, dried it, and postprocessed it to remove the surfactants as seen in FIGS. 8A and 8B. The resulting powders were spark plasma sintered and hot extruded to form the final composite. From their research they determined a direct correlation between mechanical property enhancements and increasing CNT content. The final result was a 28% increase in tensile strength, 48% increase in yield stress, and a 9% increase in hardness at 0.35 wt % MWCNTs as determined by chemical analysis.

SLM Printing of Ti-6Al-V4

When studying the effects of processing techniques on the mechanical properties of a material, it is important to understand its microstructure. Ahmed and Rack. [Reference 13] studied this phenomenon in the phase transformation of α+β Ti64 at various cooling rates. They found that during cooling, the α structure that grows from the β phase move from a coarser Widmannstatten/basket like structure to a fine, α′ martensitic structures as the cooling rates increase. FIG. 9 depicts this phase formation outcome depending on applied cooling rates.

More recently these Ti64 microstructure effect have been analyzed for the various cooling rates associated with different metal AM techniques. The driving factor for cooling rate for AM structures is the energy density (E) input into the material, defined by the equation below, where P is the power of the laser, v is the speed of the beam, h is the hatch spacing, and t is the thickness of the powder layer

E=P÷(v×h×t) (1)

These applied laser parameters can then be correlated to cooling rates equations generally associated with welding, where Q is equivalent to the power input (P), k is thermal conductivity, V is beam speed, T is temperature at a given time, and T0 is preheat.

$$\frac{d T}{d t} = - 2 π k v ( {( T - {T}_{0} )}^{2} / Q ) \qquad ( 2 )$$

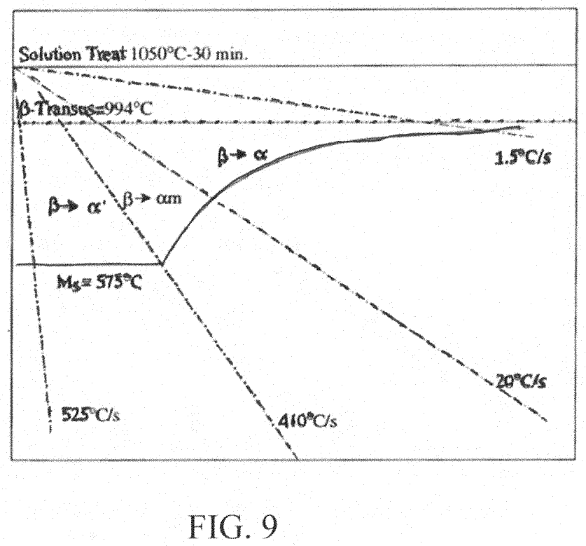

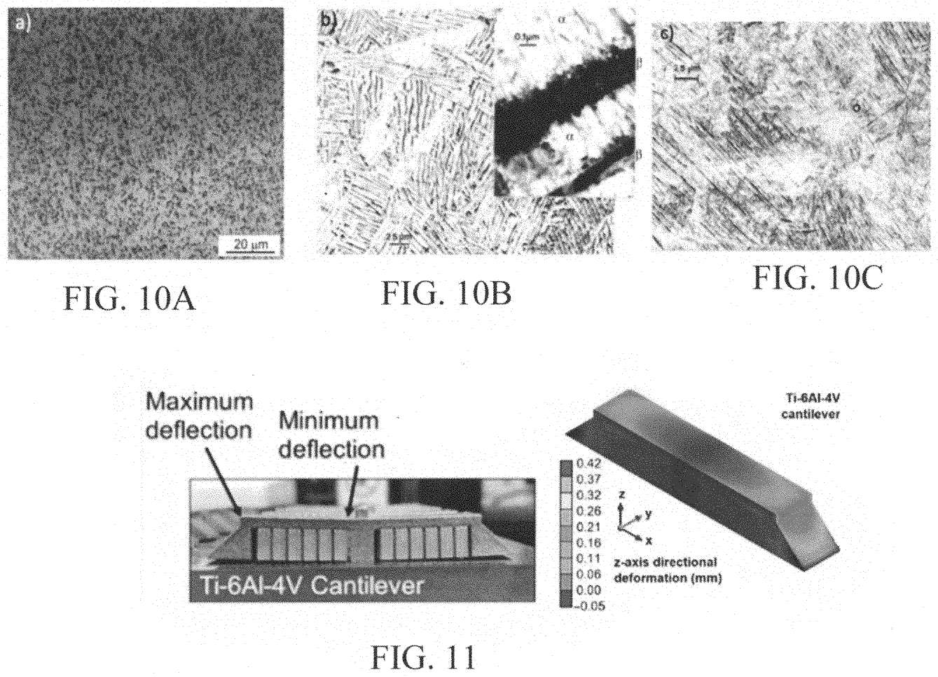

This equation shows that the cooling rate increases with decreasing Q/V (or P/v in relations to SLM printing). Murr et al. [Reference 4] and Rafi et al. [Reference 2] similarly assessed this, showing that the higher cooling rates of SLM, on the order of 106 K/s, was due to the high energy input and high raster speeds (v) compared to other AM methods such as EBM. Additionally, unlike EBM, SLM lacks any sort of preheating, which further contributes to its higher cooling rate. The end result is the expected α′ dominated microstructure pictured in FIG. 10C, making the material stronger, harder, and less ductile.

Along with the microstructure effects, the high cooling rates associated with SLM lead to large thermal and residual stresses in the manufactured parts. Yakout et al. [14] studied these effects, showing that the stresses were at a maximum at the longitudinal ends of produced part and minimized in the center as depicted in FIG. 11. This can prove a difficult challenge to overcome when printing parts with extended dimensions in the x- or y-direction.

Thijs et al. [Reference 15] came up with a laser scanning strategy, known as “island scanning” to overcome these thermal stresses. They achieved this by dissecting the part to be printed into 5×5 mm² segments, each with its own scan direction. For each subsequent layer the scan direction was adjusted 90°, and the segment was shifted 1 mm to provide a counter stress to the previous printed layer. However, the ability to accomplish this is limited to the freedom of interface with a given printer's software.

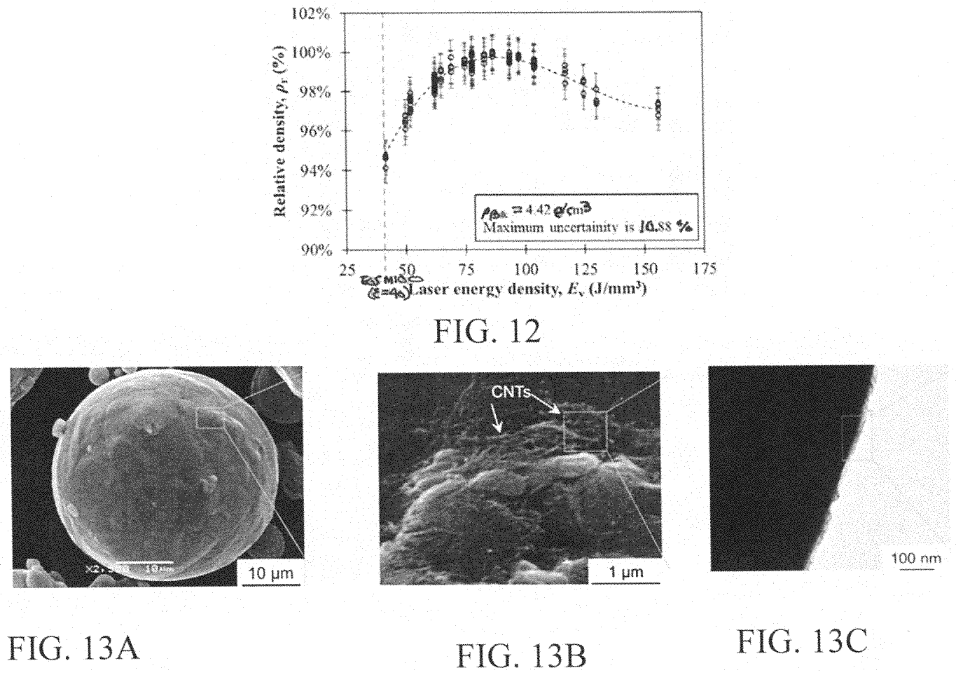

Density is the one of other main concern when it comes to the 3D printing of any material, as it can have a great effect on the mechanical properties of the final part. Several groups have conducted optimization and parametric studies to determine the necessary laser energy density (E) necessary to produce >99% dense Ti64 parts. While they do not all agree on the ideal energy density (E), all of their data generally take the shape of that seen in FIG. 12. From this graph an initial increasing part density in conjunction with increasing E, due to improved melting of the powder, up until an energy density of 86.8 J/mm³ (99.9% dense). Further increases in E above this point results in decreasing density of the part speculated to be the result of splashing of the melt pool, constituent vaporization, and/or keyhole formation combined with rapid cooling and solidification [Reference 16]—[Reference 19].

### SLM Printing of Ti64-CNT Composites

All the above-stated considerations for SLM printing play a significant role in producing a Ti-CNT composite. However, there are two additional challenges which must be considered: maintaining powder flowability and achieving a homogenous distribution of CNTs in the finished part. For most commercial SLM printers, there is a limited tolerance to the size of the powder that the re-coater can pass through in order to laydown each layer of powder. If the powder exceeds this tolerance the spread layer can become non-uniform, which can lead to structural failure or excessive porosity of the part. Methods described above to achieve homogenous CNT dispersion such as mechanical mixing and surfactants can generate non-uniform particle size distribution due to bead fusion and dried byproducts respectively. Gu et al. [Reference 20] overcame this by using a process of “low energy” ball-milling, which entails a low ball-to-powder ratio and low mixing speeds. Through this they were able to achieve CNT coated Ti powder, with minimal change to the powder morphology—seen in FIG. 13A-13C.

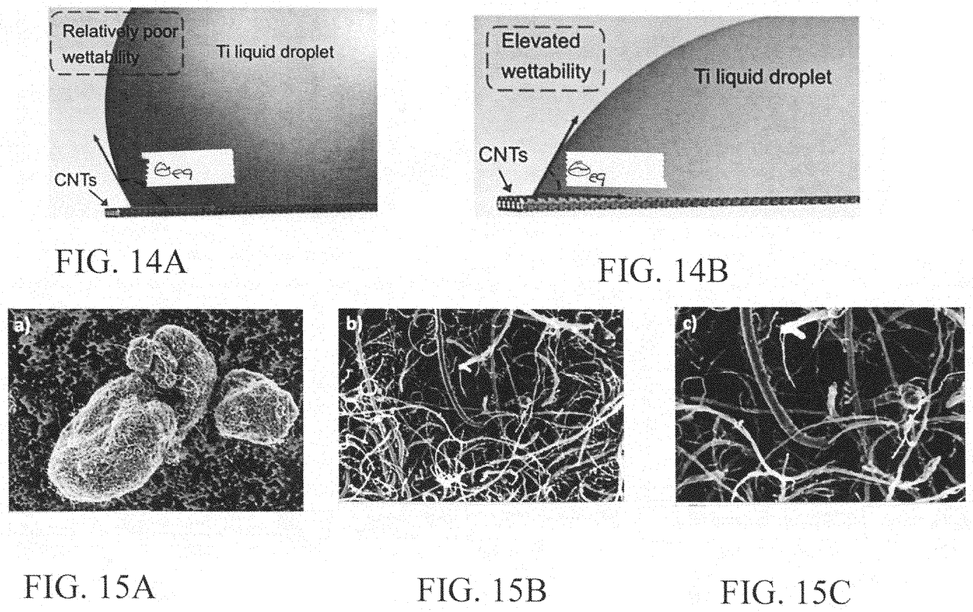

However, just because CNT dispersion has been achieved on the powders, does not mean the CNTs will not re-agglomerate within the molten pools prior to solidification. It has been shown that within the SLM generated melt pools there are very large temperature gradients due to the rapid heating (3,000 K within 1.1 ms) and cooling (−106 to −108 K/s) which takes place. This results in strong convective, Marangoni flows, which combined with the viscosity of the molten titanium is enough to overcome the Van der Waals forces of attraction between CNTs. This effect drives them to rearrange homogenously throughout the pool prior to rapid solidification [Reference 18], [Reference 20]. Chang and Gu [Reference 18] further showed that as the laser power increases, the temperature of the melt pool increases, therefor decreasing the surface tension at the liquid-solid interface. The end result is an increased wettability of the titanium onto the CNTs (FIGS. 14A and 14B), subsequently enhancing their interfacial bonds within the matrix.

Experimental Procedure:

Composite Powder Synthesis

MWCNTs were selected over SWCNTs for reinforcement due to their availability and survivability during processing. By nature and name, the MWCNTs are composed of several rolled up graphene sheets, or walls, allowing them to sustain more damage during mixing while reducing the probability of degrading their desired, inherently strong structure. Additionally, they can be produced much more readily and are therefore more widely available and affordable, enabling a more readily producible composite to be manufactured at scale. The MWCNTs used (FIG. 15A-15C) have an average length of 10-30 um, diameter 10-20 nm, and purity of >95 wt % (<1.5 wt % ash).

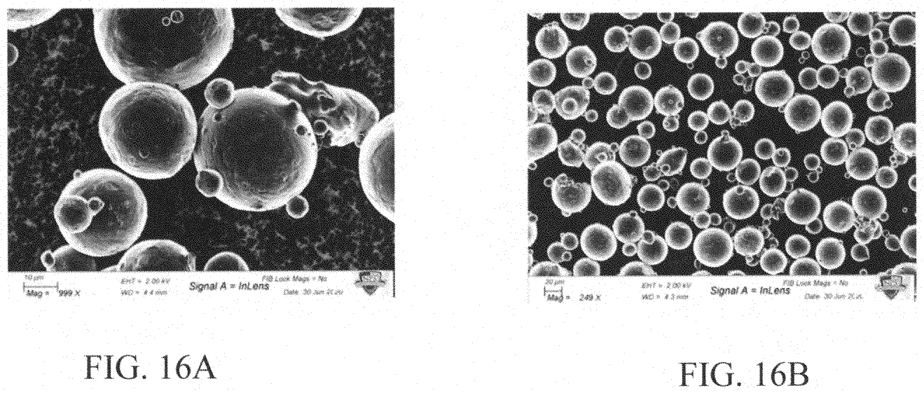

The bulk matrix material is a proprietary Ti64 powder procured from EOS North America which satisfies ASTM F2924 chemical composition standards and has average particle size of 39±3 μm for use with their M100 metal 3D printer and associated license [Reference 21]. Table 1 indicates the chemical composition of the powder, and FIGS. 16A and 16B depicts the general size and morphology of the bulk powder as received from the manufacturer.

TABLE 1
Chemical composition of Ti64 powder. Source: [Reference 30].

| Element | Al | V | O | N | C | H | Fe | Y | Other | Ti |
|---|---|---|---|---|---|---|---|---|---|---|
| Min | 5.50 | 3.50 | — | — | — | — | — | — | — | bal. |
| Max | 6.75 | 4.50 | 0.20 | 0.05 | 0.08 | 0.015 | 0.30 | 0.005 | 0.40 | |

The method for synthesizing the Ti-CNT composite powder was via an iterative application of high-energy ball milling (SPEX Sample Prep 8000M Mixer/Mill machine) in order to achieve a uniform distribution of the MWCNTs onto the Ti64 powder beads. This was accomplished by combining CNTs and steel milling balls (3 mm, 0.1 g) into hardened steel vials at various ball-to-powder ratios (BPR) while applying varying mill times, rest times, and number of cycles. The starting point for this was driven by previous work conducted by Ansell et al. [Reference 22] in the effects of high energy ball milling on 3D printable powder morphology.

Milling times were minimized to prevent excessive structural damage of the CNTs and large deviations in powder size and morphology. Rest times were utilized to prevent overheating which can drive TiC formation, CNT oxidation, and cold-welding of Ti64 beads. Previous work by Woo et al. [Reference 23] showed success in applying a lubricant to reduce CNT agglomeration, which was replicated here in the cycle marked with an asterisk (*). Table 2 documents the processes assessed to achieve ideal mixing:

TABLE 2
Summary of high energy ball milling
methods for composite powder mixing

| | Mill Time | Rest Time | | Total Mill Time |
|---|---|---|---|---|
| BPR | (min) | (min) | Cycles | (Min) |
| 1:10 | 2 | 5 | 10 | 20 |
| 2:1 | 5 | 5 | 5 | 25 |
| 2:1* | 5 | 5 | 5 | 25 |
| 1:1 | 5 | 5 | 5 | 25 |

*Addition of 5 mL Vertrel MS-782 (Lubricant)

For each method assessed, approximately 50 g of powder was produced using the requisite mass of steel milling balls. The powders were then mounted to carbon tape and analyzed by scanning electron microscopy (SEM, Zeiss Neon 40) to assess CNT distribution, CNT survival, and final composite powder morphology—the latter being critical for flowability of the powder necessary to achieve uniform powder bed distribution during printing. The results of this will be discussed further in the results and discussion below.

Once the necessary ball milling formula was determined, 1.5 kg of powder was produced for subsequent composite printing. Per EOS operating guidelines, the batch powder was filtered using a 63 um vibrating sieve (Retsch AS 20) and left in a furnace at 90 C for >24 hr prior to printing to remove moisture. Throughout the process of printing each batch, the powder was recycled (<15 times total) to maintain enough powder in the printer for continuous flow. This process involved combining the remaining powder and used powders via the 63 um vibrating sieve and baking in the furnace. To validate this, the powder was reassessed post recycling in the SEM to verify CNT distribution and powder morphology was not compromised. Validation of utilizing recycled powder is analyzed in results and discussion.

Selective Laser Melting Composite Processing:

Metal Additive Processing Unit

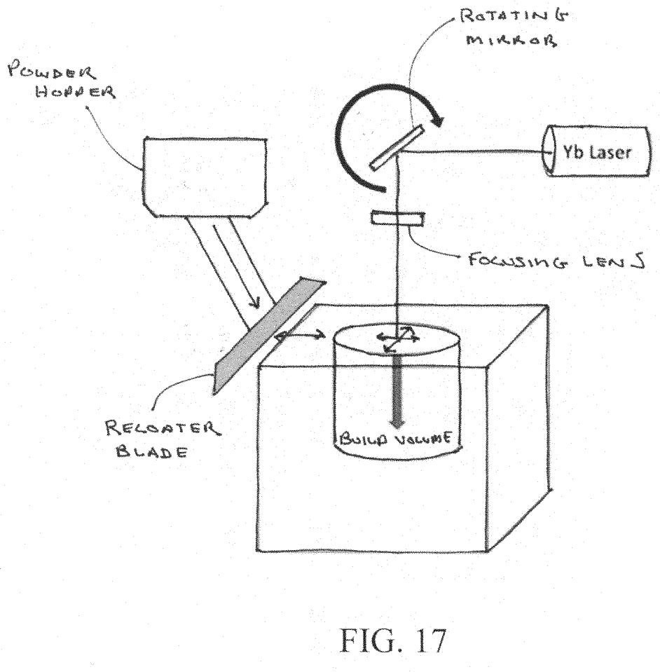

For the composite fabrication, an EOS M100 metal 3D printer was utilized, which operates via selective laser melting (SLM). The M100 is a commercially available printer, which validates the objective of being able to readily produce a scalable composite in a field application. The printer employs a 200 W ytterbium (Yb) fiber laser with a maximum print volume of 100×95 mm (D×H). This particular machine utilizes precision optics and a rotating mirror to deflect the laser in a raster pattern onto the powder bed surface at scan speeds up to 7000 mm/s. An illustration of this setup is presented in FIG. 17. As previously described for general SLM applications, to prevent high temperature oxidation, the M100 utilizes the inert gas, argon, at a purge rate of 50 L/min to maintain oxygen <0.13% during printing. In it its current setup, the printer operates on a proprietary software, EOSPRINT, in conjunction with the program MATERIALISE MAGICS to translate a user's computer aided design (CAD) into the layer-by-layer slices intrinsic to the SLM, 3D printing format—each slice equating to one 20 um thick layer of powder across the build plate for processing [Reference 24].

SLM Parameters

Within the EOSPRINT software several of the parameters which control the laser's exposure onto the powder bed can be adjusted such as: laser power (P), scan speed (v), and hatch spacing (h). It is through these variable parameters that this parametric study was conducted. Changing these parameters results in a change to the energy density (E) of the laser, which is a measure of the volumetric energy absorbed by the target powder as expressed in equation (1).

The one variable included in the equation above, not previously described, is the thickness (t) of the powder, which is not a factor of the laser, but of the physical depth of powder laid down. In this study h and t were left constant at 80 μm and 20 μm, respectively, while the P and v were adjusted to achieve a desired E. Each part produced was identified by a nomenclature associated with its desired control parameter followed by the associated value (i.e., for a desired energy density of 40 J/mm³ the part would be identified as e40). Additionally, at both ends of the spectrum two E values were held constant and the controlling parameter was the laser's power, P, while adjusting v to maintain the desired energy density. For these an additional value was added to the end of the identifier designating the power used (i.e., for an energy density 60 J/mm³ and power 125 W, the part would be identified as e60p125). While the M100 incorporates a 200 W laser, the max adjustable power is 170 W. Table 3 documents the parts studied and their associated parameters. For each composite part printed, a counterpart was produced at the same laser parameters using as-received Ti64 powder as a control group.

TABLE 3
SLM printing parameters

| Name | P (W) | V (mm/s) | E (J/mm³) |
|---|---|---|---|
| e40 | 100 | 1563 | 40 |
| e60p100 | 100 | 1042 | 60 |
| e60p125 | 125 | 1302 | 60 |
| e60p150 | 150 | 1563 | 60 |
| e60p170 | 170 | 1771 | 60 |
| e74 | 100 | 850 | 74 |
| e89 | 100 | 700 | 89 |
| e104 | 100 | 600 | 104 |
| e134 | 100 | 466 | 134 |
| e417p100 | 100 | 150 | 417 |
| e417p125 | 125 | 188 | 417 |
| e417p150 | 150 | 225 | 417 |
| e417p170 | 170 | 255 | 417 |

Part and Support Structure

The baseline geometry used for all prints and analysis was a “coupon” of rectangular cuboid shape and 5×2×2 mm (L×W×H) dimensions. Previous work had shown similar results to Yakout et al. [Reference 16] with significant thermal stresses in the longitudinal directions, that led to print failures. These print failures were often characterized by broken supports, and a bowed/warped structure, which inhibited the re-coater blade's travel.

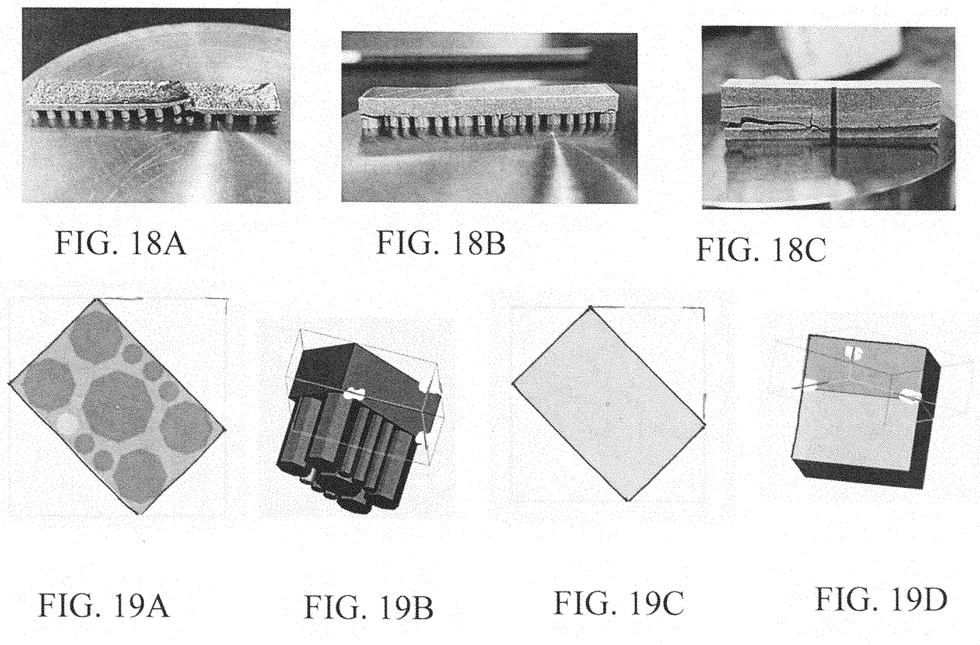

To attempt to overcome these stresses, supports were increased from cylinders of 1 mm diameter up to 4 mm diameter, and eventually a “full volume” support mirroring the parts length-width dimensions (depicted in FIG. 18A-18C). Notable, the thermal stresses can overwhelm the supports and the dimensions were reduced to that of the coupon for the testing performed. FIGS. 19A-19D shows the final composed computer aided designs used for evaluation. As the evaluation progressed, it was determined the full volume supports were required at higher laser energy densities.

Material Characterization:

Metallographic Microscopy

Preparation

Given the size of the coupon specimen, and the desire for thin samples for later analysis in x-ray diffraction (XRD), a Buehler Isomet Low Speed Saw with 127×0.5 mm Diamond Wafer Blade was utilized to section the printed parts. The sectioned parts were then mounted into pucks using SpeciFix, which were subsequently mechanically polished with up to 1200-grit paper, and finished with 1 um suspended alumina solution. For further microstructure analysis the mounted specimen were etched using Krolls Reagent (100 ml water, 1-3 mL HF, 2-6 mL HNO₃) via immersion for 30 s.

Optical Microscopy

The finely polished and/or etched specimen were analyzed using a brightfield imaging via a Nikon EPIPHOT 200 optical microscope. Contrast was enhanced using a polarizing lens, and images were captured from 25× to 500× magnification.

Scanning Electron Microscopy

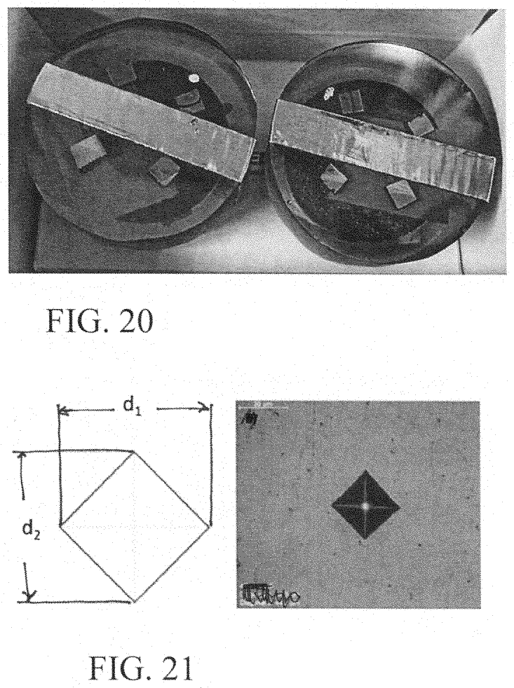

For imaging at higher magnification of the section parts and powders, a Zeiss Neon 40 scanning electron microscope (SEM) was used. To prevent charging of the sample during imaging, puck mounted samples were sputter coated with 4 nm of Pt/Pd using a Cressington 208HR sputter coater in conjunction with copper tape to prevent charging during imaging (FIG. 20). Ti64, CNTs, and composite powders were analyzed by dipping a carbon taped mount into the respective powder to be analyzed. Imaging was conducted through a 30 um aperture, at an approximate working distance of 5 mm, and a range of accelerating voltage from 2 kV to 20 kV.

Microhardness

Microhardness data was collected using a Struers DuraScan applying a 0.5HV load, which operates by pressing a diamond cone into the surface of the material. The machine was set to utilize Rockwell Hardness, HRC test, applying 1471 kN load subsequently followed by an automated scan of the indentation's dimensions at 40× optical magnification. The DuraScan then assesses the dimensions based on the captured image and dimensions depicted in FIGS. 21A and 21B. Using the following equation, the hardness is determined via a Vickers EN ISO 6507 look up table based on the value d.

d=(d₁+d₂)/2 (3)

Ten measurements were taken across each specimen with adequate separation distance to prevent skewing subsequent measurements. If during the measurement process it was determined an outlier (>2 standard deviations) was recorded, an additional measurements were taken.

Density

To assess the density of the produced parts OM images were captured of the highly polished cross-sections at the lowest magnification (25×). At this magnification nearly the entire cross-section was captured for each segmented coupon. The captured images were then processed using ImageJ software tools to assess for percent porosity. The resulting density was determined by subtracting the percent porosity from 100%.

X-Ray Diffraction (XRD)

To prepare the samples for XRD, a section <2 mm was cut from each printed coupon using the diamond saw referenced above, and polished to a level plane. The resulting piece was mounted to a glass slide within the XRD mount using calcite. XRD was performed utilizing a Rigaku MiniFlex 600 with an excitation voltage of 40 kV and current of 15 mA. Initial runs were conducted across a 20 to 120 degrees (2-theta), at a step of 0.01 degrees, and a speed of 5 degrees per min. XRD analysis was conducted to determine the crystal structures present within the printed part in order to identify the phases and constituent make-up of the composite—especially the presence of TiC. CNTs are not expected to be detectable via XRD due to the small volume fraction added and the nanometric dimensions of the particles.

Results and Discussion:

Composite Powder Preparation

To produce the initial composite powder high-energy ball milling was used as discussed in the experimental section to uniformly combine the Ti64 and MWCNTs. The desired result of this process was to have a composite powder with uniform distribution of CNTs onto the Ti64 powder, and a morphology which supports ideal flowability for printing. To assess this milling cycle times were adjusted in accordance with Table 2, and the resulting powders were analyzed. The first milling sequence assessed aligned with previous work conducted at Naval Postgraduate School utilizing involving a 1:10 BPR and a 2 min on, 5 min off cycle time for 10 cycles.

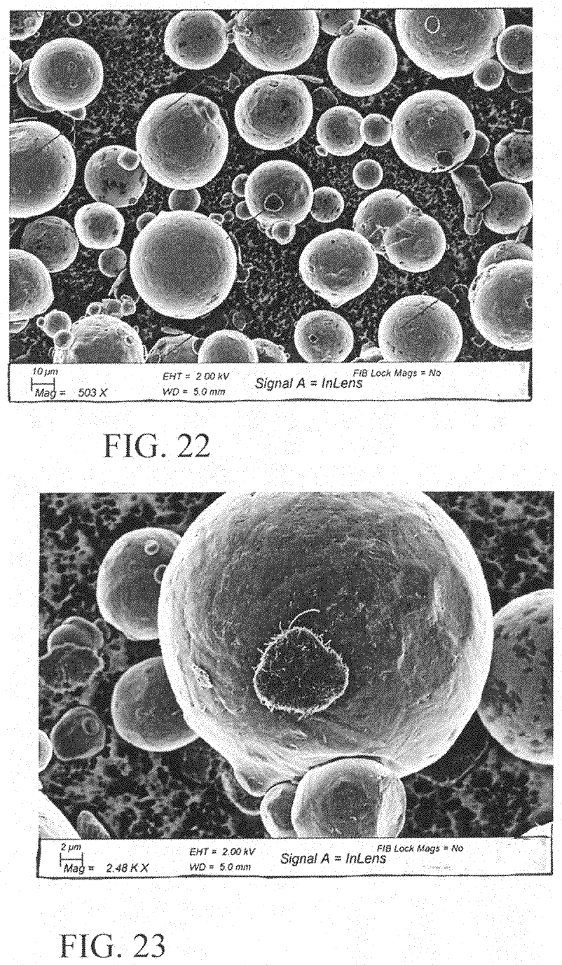

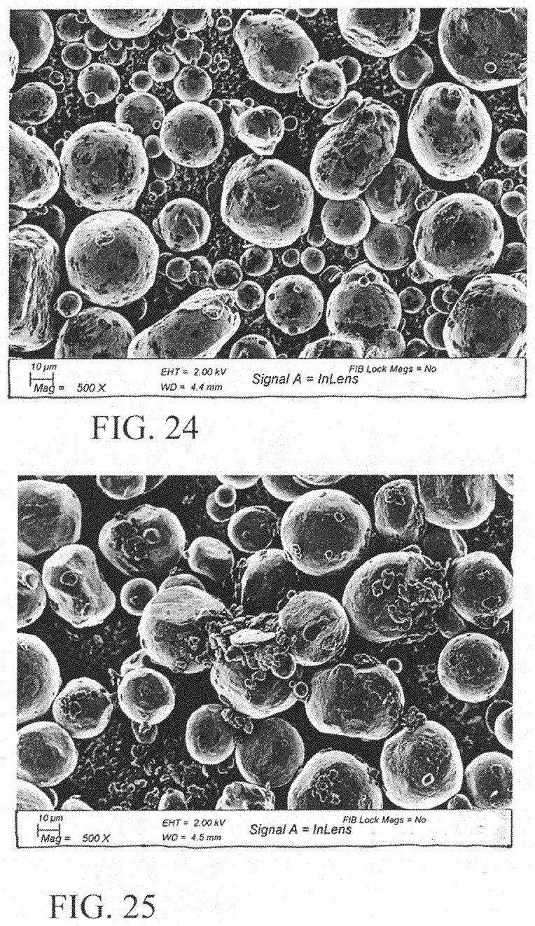

FIG. 22 and FIG. 23 illustrate the resultant powder produced from this cycling. While the overall powder morphology remains consistent in size and shape to the base powder, this lack of CNT deagglomeration and adhesion to the powder is not the desired effect. A larger amount of strain energy was required to break up the bundles, so in the next sequence the ball to powder ratio was increased to 1:1 and the cycle time between successive rests was raised to 5 min. As shown in FIG. 24, a much more uniform dispersion of CNTs was achieved, with no apparent disassociated bundles. However, the CNTs that were attached to the powder beads, remained somewhat agglomerated.

Further analysis was sought to determine if CNTs could be further de-agglomerated while maintaining dispersion and powder morphology. From here the milling cycle was maintained while further increasing the BPR to 2:1. In addition to this, as previously discussed, Woo et al. [Reference 23] had shown success with adding a lubricant to help reduce the strain energy required to de-agglomerate the CNTs. To explore this effect, 5 mL of Vertrel lubricant was added to one of the two, 2:1 BPR batches of powder to be milled.

In FIG. 25, it can be seen that the addition of lubricant with the increased BPR had almost a countering effect when compared to FIG. 26. In the lubricant sample numerous large CNT clusters still exist, where there are none in the dry sample at similar BPR and cycle times. Instead of the lubricant acting to reduce the strain required for de-agglomeration of the CNTs, the lubricant appears to have reduce the strain energy imparted by the milling balls onto the powder beads and CNT bundles. This is evidenced by the same milling sequence applied to the non-lubricated sample, which achieved a uniform dispersion of CNTs and no apparent bundles observed. FIG. 27 provides further indication of not only satisfactory dispersion of the CNTs was achieved, but survival of the CNT structure was maintained.

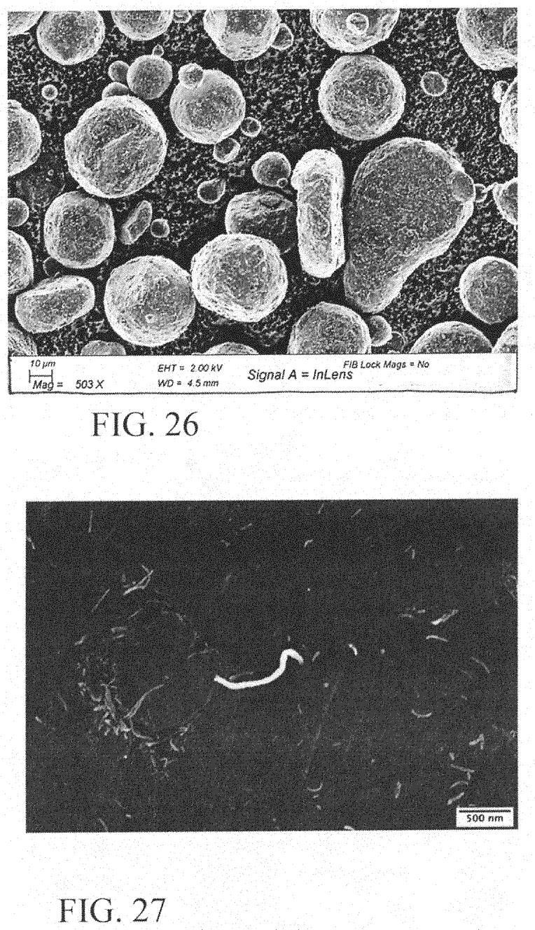

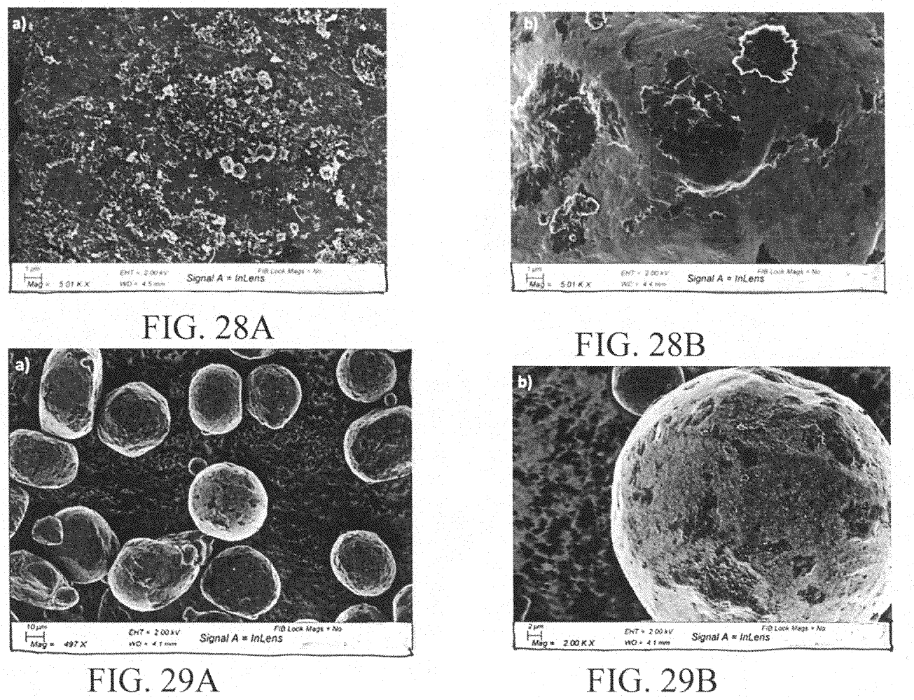

FIGS. 28A and 28B further illustrates this comparison of the resultant 1:1 BPR and 2:1 BPR composite powders.

As discussed in the experimental methods, once the correct milling recipe was determined, 1500 g of powder was produced over a period of 800 min. It was determined during printing that each print would consume approximately 100 g of coupon print, with more being lost during early, failed, large geometry prints. However, only a fraction of the powder used went into producing the part (failure or success). To improve efficiency of the composite fabrication process, the powder was recycled once there was no longer enough to complete a subsequent print. To validate that the recycled powder was viable and did not diverge from the base composite powder, SEM analysis was conducted. FIGS. 29A and 29B shows that the recycled powder morphology and CNT dispersion remains similar to that of the original produced (2:1 BPR) composite powder after <15 recycles.

Microstructure Characterization:

Material Composition

Density

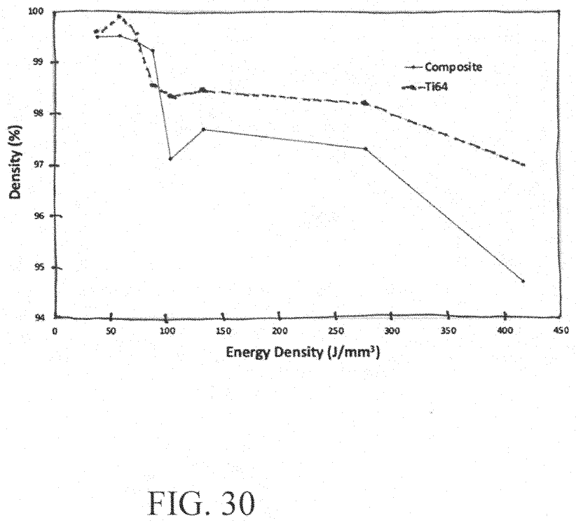

As previously discussed, controlling part density is one of the inherent challenges associated with SLM printing of metals. FIG. 30 shows the trend of printed part density with laser energy density according to this disclosure. It follows the general curve associated with previous Ti64 SLM studies as depicted in FIG. 12.

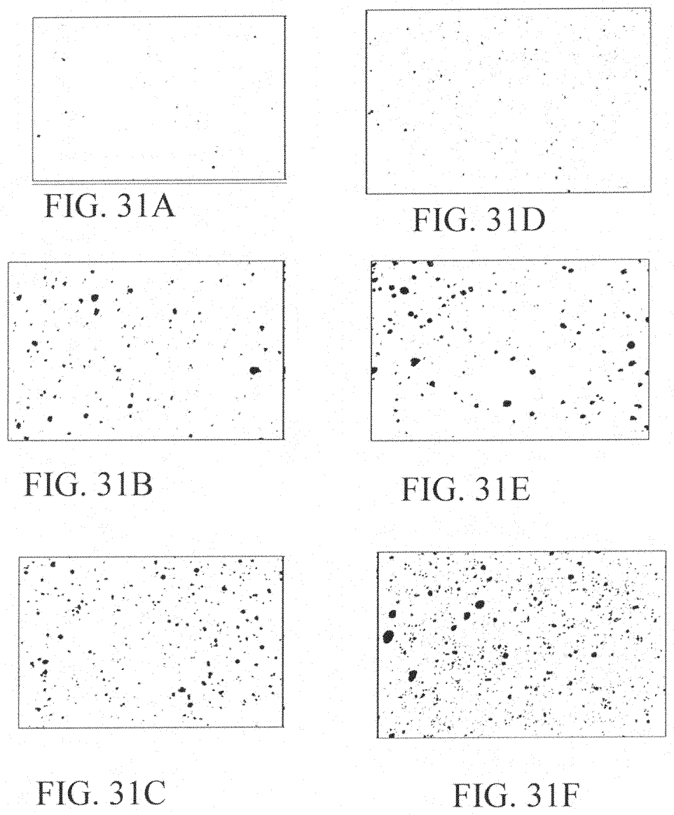

For both the Ti64 and composite printed samples, a similar trend is followed of increasing part density up to its zenith at an energy density of 60 J/mm3, and then decaying with further increases of energy density. The maximum densities achieved for the Ti64 and composite were 99.9% and 99.5% respectively. The initial increase in part density with increasing E is due to improved melting of the powder. At low E the porosity is driven by the release of gas entrained in the powder beads from their commercial production, and/or a lack of complete melt powder [Reference 25]. However, further increases beyond the critical E value, results in numerous possible, deleterious effects due to effects within the melt pool. Different cooling rates at the surface and subsurface of the melt pool are caused by differences in heat transfer via convection vs conduction respectively. This drives the formation of convective Marangoni flows within the molten liquid. Qiu et al. [Reference 19] showed that higher scan speeds can produce longer, but more shallow melt pools and therefor increased gradients leading to splashing of the molten metal, which subsequently solidifies due to large cooling rates of SLM. However, juxtaposed to that, low scan speeds and/or too high of a power can lead to excessive energy density with in the melt pool, which can cause vaporization and keyholing, resulting in voids within the material upon rapid solidification [Reference 19], [Reference 25]. A comparison of these effects at low and high E can be seen in the imageJ profiles of FIGS. 31A-31F, used to assess the part densities.

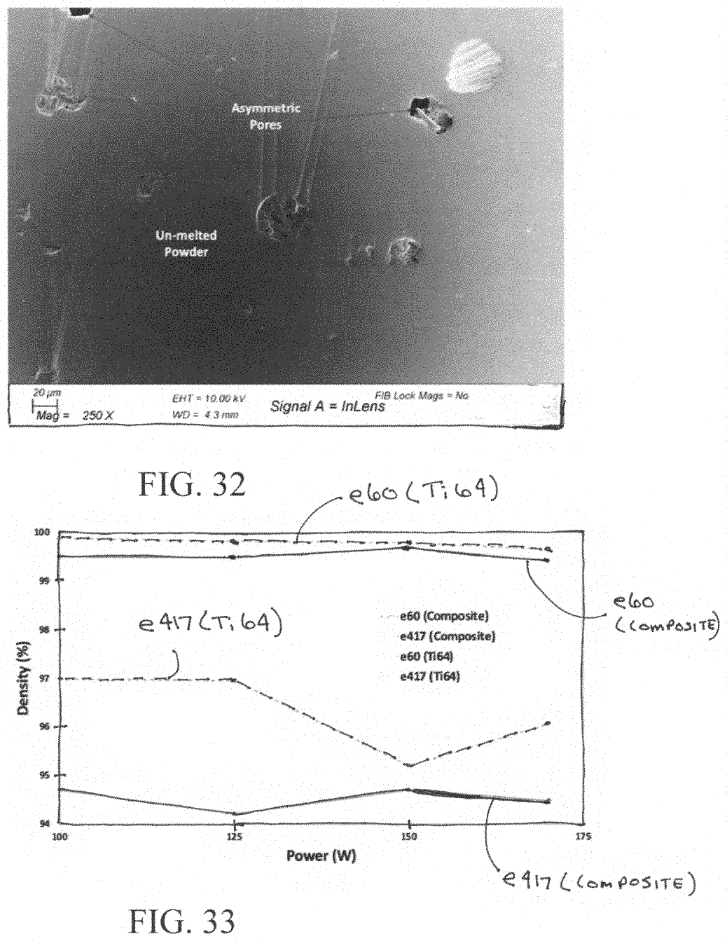

The pores generated at low E, due to the release of entrained gas, are generally small and nearly symmetrical as observed in FIGS. 31A and 33D. However, at higher energies the effects of molten splashing, vaporization, and keyholing result in larger, asymmetric pores, and even un-melted beads of powder due to the large temperature gradients within the melt pool combined with a short solidification time. A clearer example of these effects can be seen with the SEM in FIG. 32.

Looking back at FIG. 30, another important observation is that the printed composite parts are overall less dense than their printed Ti64 counterparts for a given E value (with the exception of e89). This is likely due to the large thermal conductivity of the CNTs (up to 3000 Wm−1 K−1 [Reference 26]), which further exacerbates the magnitude of thermal gradients within the melt pool, and the associated negative effects. To better understand these effects and those created by printing parameters, a further investigation was conducted holding E constant while adjusting the lasers power and correlated scan speed.

FIG. 33, illustrates, again, that the overall porosity increased with increasing E, and was higher overall for the composite sets. However, of important note is that there is little to no significant change in the porosity for a given change in power. This demonstrates that the primary contributing factor affecting the final density of the part is input laser energy density of the system. Having this understanding of the effects of the laser energy density and carbon nanotubes on the SLM printed composite parts can allow for control of tailorable properties for a desired application.

Composition (XRD)

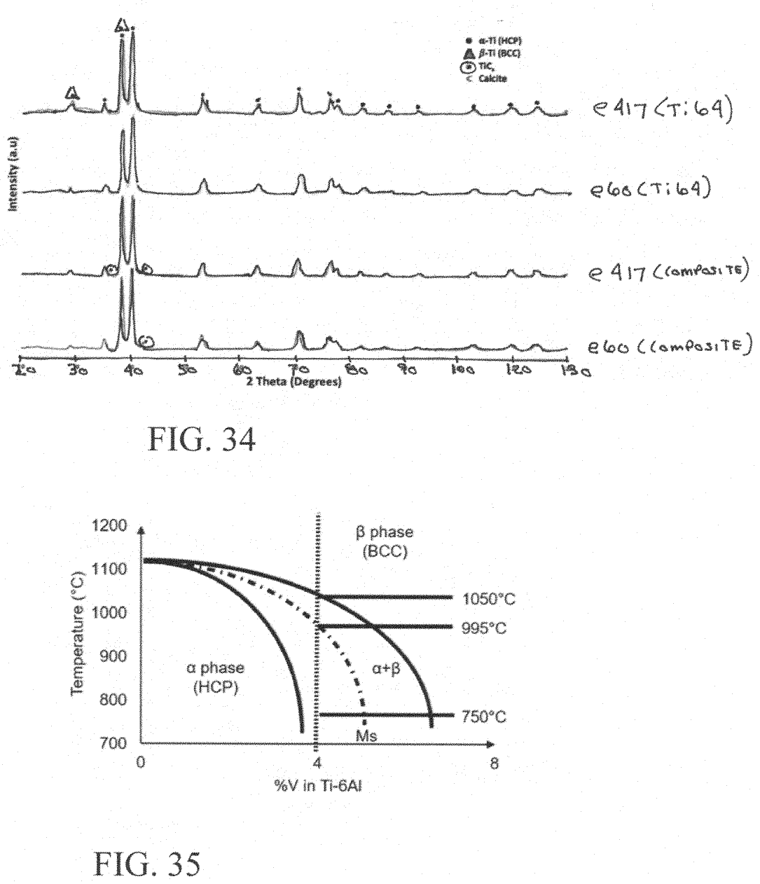

XRD was used to characterize and identify crystalline phases present and the possibility of carbide formation in the final printed part. The XRD pattern for the printed Ti64 and composites are illustrated in FIG. 34.

The diffraction pattern for the all samples show peaks which predominantly align with those of α-phase (HCP) Ti. However, the peak at a 2θ≅38.41° intensity is greater than expected for only α-Ti, which can be attributed to the contribution of counts for β-phase (BCC) Ti whose primary peak corresponds to this location. The two titanium phases observed are expected for Ti64 as illustrated in phase diagram in FIG. 35, with the majority contribution from the α-phase at room temperature. The additional peak at 2θ≅29° for all plots is associated with calcite used in preparing the samples for XRD analysis.

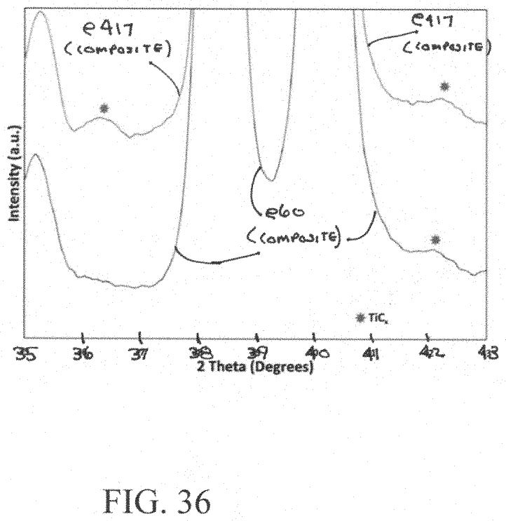

These peaks and their identities are directly reflected in the diffraction pattern produced for the composite samples, however there are two additional, unidentified peaks of lower intensity which can be observed at 2θ≅36.25° and 42.25°. FIG. 36 shows an amplified XRD plot of the analyzed composites to better illustrate these peaks.

Gu G C et al. [Reference 20] showed that for SLM produced Ti-CNT composites, peaks can occur in this vicinity, which are associated with non-stoichiometric titanium carbides (TiCₓ). At the temperatures within the SLM melt pool, the Gibbs free energy for TiC formation is less than zero (−136.178 kJ/mol), allowing for its spontaneous formation [Reference 28]. However, due to the rapid cooling rates and subsequent solidification time associated with SLM, the diffusion length of carbon within the liquid state, BCC, titanium matrix is limited, resulting in unfilled interstitial sites. As this is not a uniform process, the quantity of carbon interstitials can vary (i.e. TiCₓ E 0<x<1) based on localized temperature gradients and cooling. The amount and location of the carbon interstitial creates strain on the crystal lattice, changing its spacing (d), which controls the location the 2-theta peak in accordance with Bragg's Law.

$$d = \frac{n λ}{2 sin θ} \to 2 θ = 2 * {sin}^{- 1} ( \frac{n λ}{2 d} ) \text{=>} ↓ d ∝ ↑ 2 θ \qquad ( 4 )$$

The primary peaks for TiC occurs at 2θ=36° and 42°.

With TiCx the reduced number of carbon interstitials results in less lattice strain, resulting in a smaller d-spacing and an associated peak shift to the right as is observed. The formation of the TiCX is likely the result of a reaction between Ti and carbon from destroyed CNTs in the milling process, and/or its formation at the Ti-CNT interface. Both are desirable for enhancing the properties of the titanium, but the latter is ideal for transferring the coveted strength characteristics of the CNTs to the matrix.

Microstructure

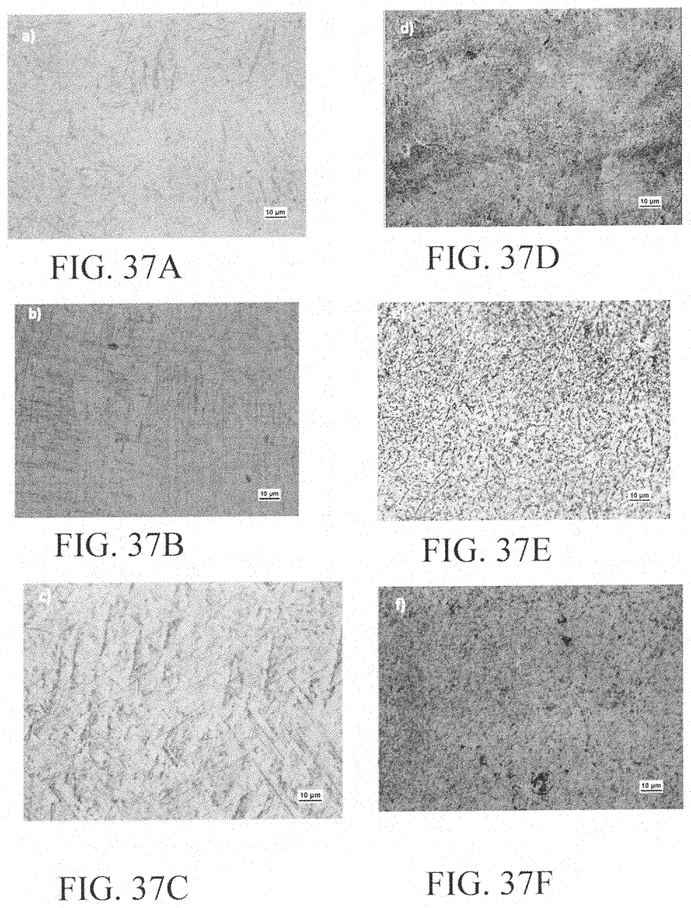

Etched cross-sections of each sample were analyzed via OM and SEM in order to positively identify the material's microstructure, which is essential for understanding the mechanical effects of their production. Observations were recorded for the printed Ti-CNT composite across a range of laser energy density values, as well as for a control group of pure Ti64 printed at like parameters. FIGS. 37A-37F show the resulting optical microscope images of the composite and control at a magnification of 500×.

Looking first at the Ti64 samples in FIG. 37A-37C the dominant a′ phase, previously defined here by its characteristic acicular, needle-like structures, is visible in all three images. However, as the energy density input increases from 60 J/mm3 to 417 J/mm3, the distinctive needles of the a′ structure visibly become finer, and the prior β-grains that they extend from become smaller as described in previous studies [Reference 29]—[Reference 31]. This is due to the higher temperatures within the melt pools, and a subsequently larger cooling rate associated with the increasing laser energy density. The higher temperatures result in a decreased critical radius for crystallization, combined with the large supercooling results in more grain nucleation sites and finer martensitic needle structures [Reference 32].

Comparatively, the composite's microstructure in FIG. 37D-37F shows a much more refined microstructure, with shorter, finer needle structures, as well as what appear to be carbide precipitates. Of note, there appears to be far less difference in the composite microstructure as the energy density increases compared to the Ti64 pieces.

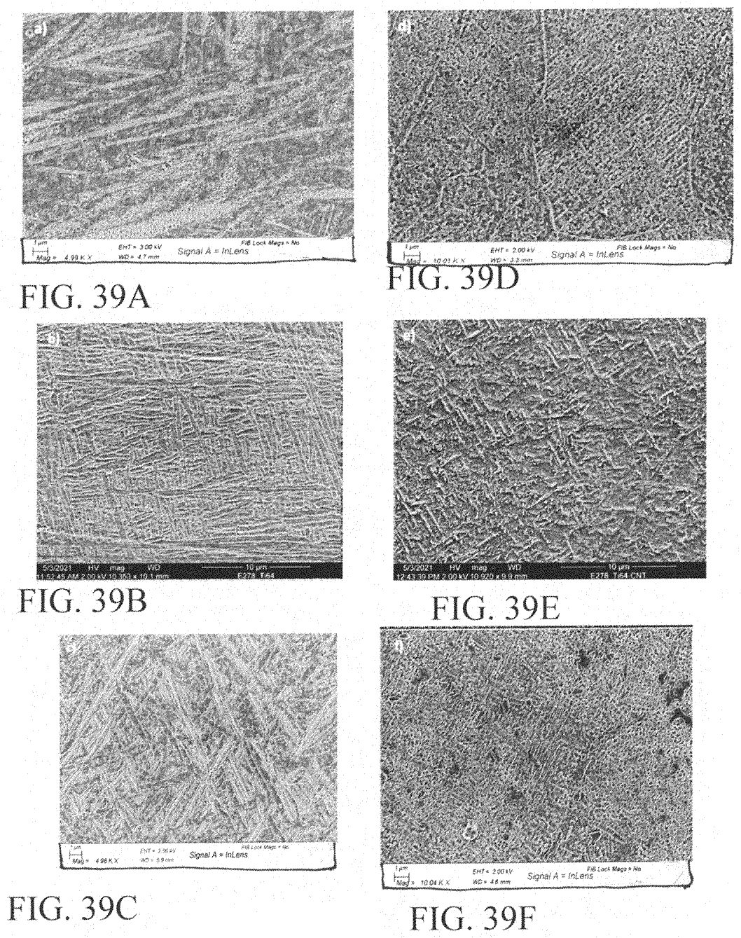

To get a better understanding of these microstructures higher magnification was desired and achieved via SEM. The images in FIGS. 39A-39F provide a much clearer distinction of the observations above. The coarseness of the α′ structure in the Ti64 compared to the Ti-CNT composite is much more obvious with SEM. As is the refinement of the needles in the Ti64 structure as E increases. However, again the observed changes are much more subtle for the composite. The width of the needles appears to have reached a minimum (˜10⁻⁷-10⁻⁸ m), comparable throughout the energy range to those of 417 J/mm³ in the Ti64 set. This could be ascribed to the high thermal conductivity of the dispersed CNTs [Reference 26], which could promote a more uniform, maximized cooling rate for the composite. Related to this, another notable comparison is that while width stayed relatively constant, the length of the needles shortened as E increased attributable again to the high cooling rate and limited diffusion kinetics.

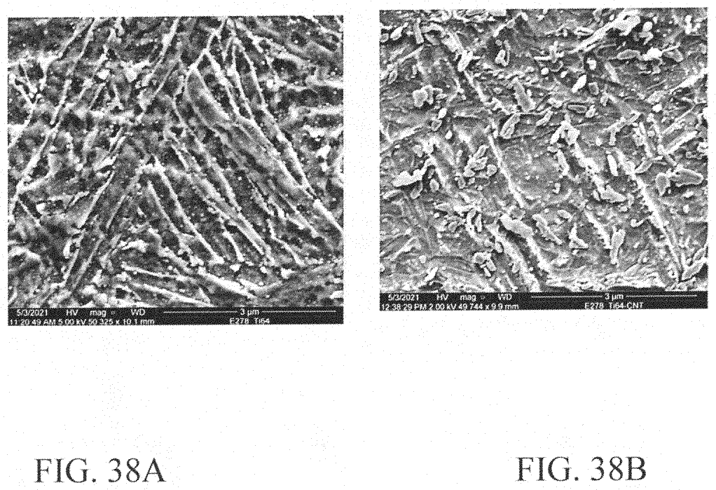

Further analysis at higher magnifications indicates another important phenomenon that is unique to the composite specimens' microstructure as seen in FIGS. 38A and 38B. Post etching analysis in the SEM reveals what appear to be carbide formations on the surface of the composite at all energy densities, which is not observed in the reciprocal, control samples. Limitations of this evaluation presented here prevented their direct identification via energy dispersive spectroscopy, but the visual observation is corroborated by the XRD results previously discussed, and those of Gu et al [Reference 20].

Effects of CNTS and Printing Parameters

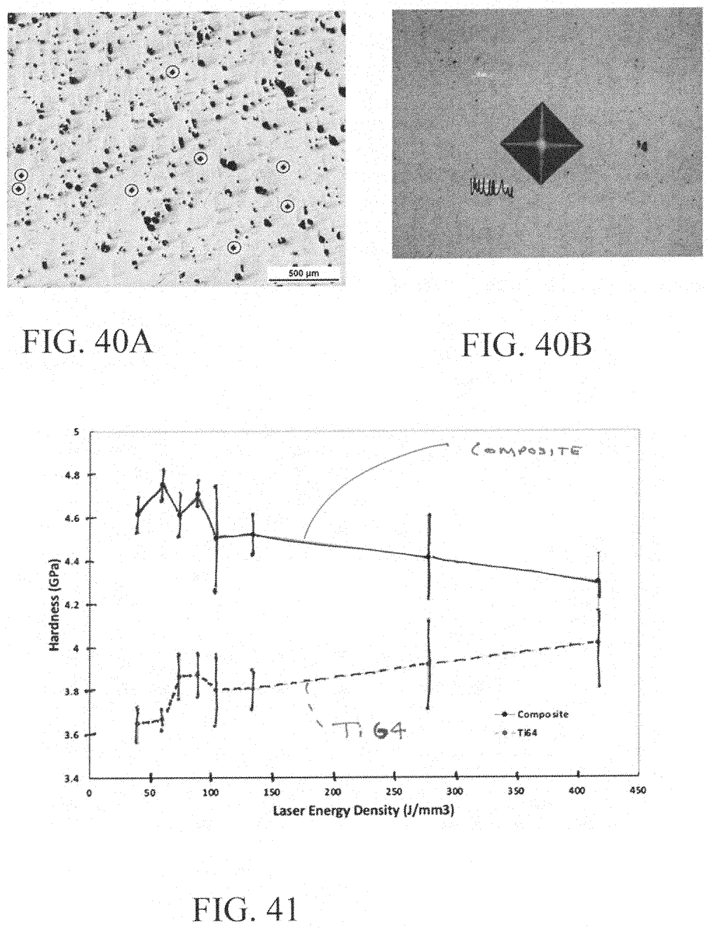

Microhardness testing was accomplished throughout the cross-section of each of the printed Ti64 and composite specimen. As depicted in FIG. 40A, locations for the application of the measurement were chosen based on ensuring adequate distance was maintained between each subsequent indentation and pores on the surface. FIG. 40B shows a satisfactory indentation, indicated by the clean lines of a diamond impression in the surface.

Ten measurements were taken for each set, however if an outlier occurred (>2<), additional measurements were taken to prevent skewing of the data. The average and standard deviation (<) of the recorded values were calculated, and plotted for all samples e40 to e417, in FIG. 41. This was done to assess the effectiveness of the CNT reinforcement of the composite in comparison to its Ti64 counterpart, as well as to illustrate the effects of laser energy density (E) on the produced parts.

FIG. 41 shows that for all laser energy densities, the composite part outperformed the Ti64 part in hardness. The hardest part produced in this study occurs at 60 J/mm3 with a hardness of 4.75 GPa. This is also the location of the largest difference between like-printed parts, showing an increased hardness of 30% for the composite over its Ti64 counterpart and 45% increase over wrought. Of note, this same E value is responsible for the peak, part density value in this study. From the information and data that has been presented up to this point we can attribute the resulting increased hardness of the Ti-CNT composite to three, synergistic effects: microstructure, carbide precipitation, and fiber reinforcement.

Looking at the trend of the plots, the composite parts show a decreasing hardness with an increase in laser energy density beyond 60 J/mm3. As discussed above, the addition of CNTs to the printed parts resulted in a much finer grain structure than their Ti64 counterparts. These smaller grains act as dislocation pinning sites, hindering dislocation mobility and increasing the hardness of the material. However, this effect reaches a maximum at 60 J/mm3, before porosity begins to grow with further increases of E (FIG. 30) resulting in a downward trend of hardness. The dominating factor, driving the decrease in hardness can be correlated with Duckworth-Ryshkewitch law [Reference 33] represented in the equation below where, S, is strength of fully dense part, So, is strength of porous part, P, is the porosity of the part, and b, is a constant.

Sₒ=Se^{-bP} (5)

This equation shows that as porosity increases for a given material, its strength (αHardness) decreases at a near exponential rate. While this effect would still apply to the Ti64 parts, the dominant effect responsible for its increasing hardness with E can be attributed to the Hall-Petch relationship below where, σ, is strength and d, is grain size.

$$σ ∝ \frac{1}{\sqrt{d}} \qquad ( 6 )$$

At E>60 J/mm3, the Ti64 parts had less porosity overall than their composite equivalent but showed a much more significant reduction in grain size as the energy density increased.

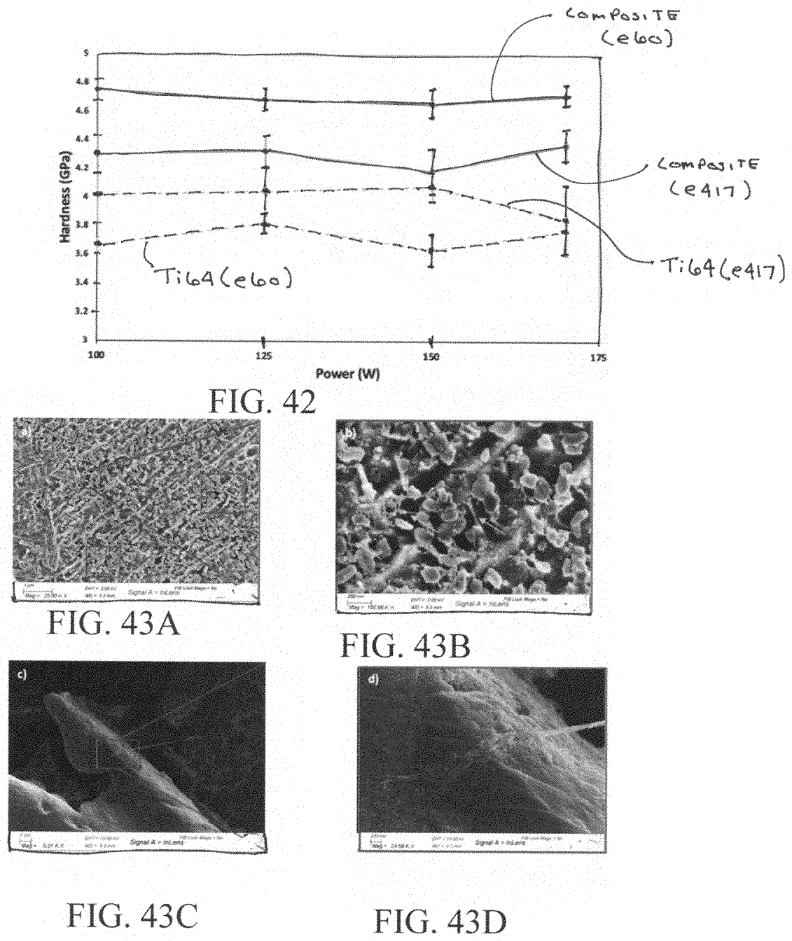

These effects are further emphasized in FIG. 42, which shows little to no change in hardness when E is held constant and laser power and associated scan speed are adjusted in accordance with Table 3. This correlates with the effects described above and previous FIG. 33, which analogously exhibited little/to no change in porosity across the same changing parameters.

Microstructure Characterization results showed positive indication of TiCX formation within the printed Ti-CNT metal matrix composite. As stated there, this is likely a combination result of precipitated TiC lamellae within the composite structure and interfacial adherence between the titanium matrix and reinforcing CNTs. As Gu et al. [Reference 20] showed, the precipitation of this sub-stoichiometric carbide can act as sites where dislocations pile up during loading, increasing the strength of the material. However, the more ideal source of the TiCX formation would be its occurrence at the matrix-fiber interface. The occurrence of this would imply a strong adhesion of the reinforcing, CNT fiber with the titanium matrix.

This is where the fiber reinforcement comes into play. As discussed previously, the lower scan speeds associated with the higher E values with a constant power results in a longer dwell time of the laser for a given melt pool. It has been shown that this results in larger temperature gradients in the melt pool and an increased viscosity. The consequence of these two effects are greater Marangoni flows within the melt pool giving rise to greater de-agglomeration and dispersion of the CNTs prior to solidification [Reference 18]. This improved CNT dispersion correlates to the observed increases in hardness up to a critical point. Beyond this critical energy point, the dominant effect on hardness is due to the increased porosity from unstable melting by the laser as high E values referenced previously. With CNTs acting as a reinforcing agent for the composite, they would not only present additional dislocation pinning sites, but transfer their highly desirable strength characteristics to the matrix. The CNT reinforcement evidenced by the increased hardness and validated by the presence of CNTs observable within the final printed structure depicted in FIGS. 43A-43D.

### SUMMARY OF RESULTS

This disclosure, and the exemplary embodiments described herein, provide details of the viability and consequences of 3-D printing a novel composite material utilizing an SLM printer and a commercially available Ti-6Al-4V powder combined with 1 vol. % CNTs as reinforcement. The initial phase focused on the production of a composite powder without compromising flowability within the printer. This was achieved using high energy ball milling and a BPR of 2:1. From there assessment of the effectiveness of the CNT reinforcement, and the outcome of adjusting the printer's laser energy density, power, and scan speed is determined. According to one exemplary embodiment, a Ti-CNT composite was produced that was >99% dense with an increased hardness of 30%. While all printing parameters provided produced composites superior to their control equivalents, the pinnacle result was achieved at a laser energy density (E) of 60 J/mm3. At E values above and below this point, the effects of reinforcement were hindered by increasing porosity due to melt pool effects. However, the improved hardness for all composite parts is attributed to the collaborative effects of microstructure refinement, precipitation hardening, and fiber reinforcement. The combination of SLM printing's large super cooling and the CNTs ability to pin and hamper grain growth resulted in a much smaller average grain structure in the composite material. Additionally, XRD analysis confirmed the formation sub-stoichiometric TiC (TiCx for x<1) from the spontaneous reaction between titanium and carbon at melt temperatures. This carbide formation contributed to hardening of the material via solution precipitation. Through SEM analysis CNTs were identified throughout the matrix, validating their ability to survive the processing, allowing them to augment the titanium matrix through their fiber reinforcement.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

### LIST OF ACRONYMS AND ABBREVIATIONS

AM additive manufacture
CNT Carbon nanotubes
CAD computer-aided design

### DED Direct Energy Deposition

E laser energy density (J/mm3)
MMC metal matrix composite
MWCNT multi-wall Carbon nanotube
PBF powder-bed fusion
PDF powder diffraction file
SLM selective laser melting
SWCNT single-wall Carbon nanotube
TEM transmission electron microscope

### Ti64 Ti-6Al-V4

Ti-CNT Carbon nanotube reinforced Ti64 composite
TiC titanium carbide
XRD x-ray diffraction

What is claimed is:

1. A method of 3D printing carbon nanotube reinforced titanium composites comprising:
generating a composite powder by combining a titanium material and a carbon nanotube material in a high energy ball mill, wherein the high energy ball mill is used to perform multiple milling cycles, wherein each of the multiple milling cycles is approximately one to five minutes of milling followed by approximately one to ten minutes of inactivity for cool-down; and
configuring a support structure for supporting a metal component, wherein the custom support structure comprises large cylindrical support structures along an edge of a target print area of the metal component, wherein each of the large cylindrical support structures are larger than a default cylindrical support structure of a 3D printing software; and
printing, using a selective laser melting machine, the metal component and the support structure with the compositive powder.

2. The method of claim 1, wherein the carbon nanotube is a multiwall CNT of 95% or greater purity and average lengths of 10-30 μms and diameters of 10-20 nm.

3. The method of claim 1, wherein the carbon nanotube is approximately 0.1% to 3% by volume of the composite.

4. The method of claim 1, wherein the titanium material is Ti-6Al-4V.

5. The method of claim 1, the multiple milling cycles is at least ten milling cycles.

6. The method of claim 1, wherein the selective laser melting machine is configured to have a target energy density that is low enough to ensure particulates of the carbon nanotube do not dissolve.

7. A 3D printed carbon nanotube reinforced titanium composite comprising:
a carbon nanotube; and
a titanium material, particles of the carbon nanotube being embedded in the titanium material such that minimal to no porosity is exhibited at an interface of the titanium material and the oxide;
a support portion of the titanium composite arranged in a support structure for supporting a metal component comprising a component portion of the titanium composite, the custom support structure comprising large cylindrical support structures along an edge of a target print area, wherein each of the large cylindrical support structures have a minimal thickness to prevent damage caused by thermal stresses of 3D printing.

8. The 3D printed carbon nanotube reinforced titanium composite of claim 7, wherein the carbon nanotube is a multiwall CNT of 95% or greater purity and average lengths of 10-30 μms and diameters of 10-20 nm.

9. The 3D printed carbon nanotube reinforced titanium composite of claim 7, wherein the carbon nanotube is approximately 0.1% to 5% by volume and has a melting point higher than the titanium material.

10. The 3D printed carbon nanotube reinforced titanium composite of claim 7, wherein the support structure includes a plurality of different diameter cylinders.

11. The 3D printed carbon nanotube reinforced titanium composite of claim 7, wherein the titanium material is Ti-6Al-4V.

12. The 3D printed carbon nanotube reinforced titanium composite of claim 7, wherein the carbon nanotube material is uniformly dispersed throughout the titanium composite.

13. The 3D printed carbon nanotube reinforced titanium composite of claim 12, wherein the uniform distribution of the carbon nanotube material enhances oxidation resistance of the titanium composite.

14. The 3D printed carbon nanotube reinforced titanium composite of claim 7, wherein each of the particles of the carbon nanotube material are smaller than particulates of the titanium material.

15. The 3D printed carbon nanotube reinforced titanium composite of claim 13, wherein each of the particles of the oxide are approximately from −10 nm to 20 nm.

16. A method of 3D printing carbon nanotube reinforced titanium composites comprising:
generating a composite powder by combining a titanium material and a carbon nanotube in a high energy ball mill, wherein the high energy ball mill is used to perform multiple milling cycles, wherein each of the multiple milling cycles is at least one minute of milling followed by at least one minute of inactivity for cool-down;
configuring a support structure for supporting a metal component, wherein the support structure comprises large cylindrical support structures along an edge of a target print area of the metal component; and
printing, using a selective laser melting machine, the metal component and the support structure with the compositive powder.

17. The method of claim 16, wherein the carbon nanotube is 1% by volume of the composite.

18. The method of claim 16, wherein the carbon nanotube is approximately 0.1% to 5% by volume of the composite.

19. The method of claim 16, wherein the support structure includes a plurality of different diameter cylinders.

20. The method of claim 16, the multiple milling cycles is at least ten milling cycles, and the selective laser melting machine is configured to have a target energy density that is low enough to ensure particulates of the carbon nanotube do not dissolve.
